(19) United States
(12) Patent Application Publication
(10) Pub. No.: US 2012/0252937 A1
(43) Pub. Date: Oct. 4, 2012

(54) Lignocellulose Based Composite Products Made With Modified Aldehyde Based Binder Compositions

(75) Inventors: Melissa J. Cannon, Ellenwood, GA (US); Kelly A. Shoemake, Atlanta, GA (US)

(73) Assignee: GEORGIA-PACIFIC CHEMICALS LLC, Atlanta, GA (US)

(21) Appl. No.: 13/424,463

(22) Filed: Mar. 20, 2012

Related U.S. Application Data
(63) Continuation-in-part of application No. 13/228,917, filed on Sep. 9, 2011.
Application No. 13/228,917 is a continuation-in-part of application No. 12/959,136, filed on Dec. 2, 2010.
(60) Provisional application No. 61/265,956, filed on Dec. 2, 2009.

(51) Int. Cl. C09J 133/06; C09J 105/00; B32B 37/12; C08K 5/07

(52) U.S. Cl. 524/58; 156/296

(57) ABSTRACT

Lignocellulose based composite products made with modified aldehyde based binder compositions are provided. The lignocellulose based composite product can include a plurality of lignocellulose substrates and an at least partially cured binder composition. The binder composition can include, prior to curing, an aldehyde based resin and a copolymer. The copolymer can include one or more vinyl aromatic derived units and one or more unsaturated carboxylic acids, one or more unsaturated carboxylic anhydrides, or a combination of one or more unsaturated carboxylic acids and one or more unsaturated carboxylic anhydrides.

### CROSS-REFERENCE TO RELATED APPLICATIONS

This application is a continuation-in-part of U.S. patent application Ser. No. 13/228,917, filed on Sep. 9, 2011, which is a continuation-in-part of U.S. patent application Ser. No. 12/959,136, filed on Dec. 2, 2010, and published as U.S. Publication No. 2011/0165398, which claims priority to U.S. Provisional Patent Application Ser. No. 61/265,956, filed Dec. 2, 2009, all of which are incorporated by reference herein.

### BACKGROUND

1. Field

Embodiments described herein generally relate to lignocellulose based composite products. More particularly, such embodiments relate to lignocellulose based composite products made with modified aldehyde based binder compositions.

2. Description of the Related Art

A variety of composite materials including engineered wood products, are made by bonding a plurality of substrates into a unitary product using a binder or adhesive resin. Composite materials of lignocellulose have been used in a wide variety of applications and often exhibit superior properties to solid wood of similar dimensions. For example, lignocellulose based composite products are generally stronger, usually exhibit better resistance to degradation and failure, and are often more cost-effective than solid wood alone.

Lignocellulose based composite products having sufficient strength and other suitable properties can be produced with a number of different binders. To produce such lignocellulose based composite products, the binder is typically applied either as a liquid or as a powdered solid by spreading, mixing, blending, or otherwise contacting the lignocellulose substrate material with the binder. Thereafter, the mixture of the binder and lignocellulose substrate material is consolidated into a unitary product and the binder is cured, usually by heat and/or pressure to increase the density and strength of the composite product.

There is still a need, however, for improved binder compositions for producing lignocellulose based composite products as well as other composite products and methods for making and using the same.

### SUMMARY

Lignocellulose based composite products made with modified aldehyde based binder compositions are provided. The lignocellulose based composite product can include a plurality of lignocellulose substrates and an at least partially cured binder composition. The binder composition can include, prior to curing, an aldehyde based resin and a copolymer. The copolymer can include one or more vinyl aromatic derived units and one or more unsaturated carboxylic acids, one or more unsaturated carboxylic anhydrides, or a combination of one or more unsaturated carboxylic acids and one or more unsaturated carboxylic anhydrides.

The method for preparing a lignocellulose based composite product can include contacting a plurality of lignocellulose substrates with a binder composition and at least partially curing the binder composition to produce a lignocellulose based composite product. The binder composition can include an aldehyde based resin and a copolymer. The copolymer can include one or more vinyl aromatic derived units and one or more unsaturated carboxylic acids, one or more unsaturated carboxylic anhydrides, or a combination of one or more unsaturated carboxylic acids and one or more unsaturated carboxylic anhydrides.

A multi-layer lignocellulose based composite can include a core layer, a first outer layer bonded to a first side of the core layer, and a second outer layer bonded to a second side of the core layer. The first and the second sides of the core layer can oppose one another. The first and the second outer layers can each include a plurality of lignocellulose substrates bonded to one another with an at least partially cured binder composition. The binder composition, prior to curing, can include an aldehyde based resin and a copolymer. The copolymer can include one or more vinyl aromatic derived units and one or more unsaturated carboxylic acids, one or more unsaturated carboxylic anhydrides, or a combination of one or more unsaturated carboxylic acids and one or more unsaturated carboxylic anhydrides.

### DETAILED DESCRIPTION

The binder composition can include at least one aldehyde based resin and at least one copolymer. The copolymer can include one or more vinyl aromatic derived units. The copolymer can also include one or more unsaturated carboxylic acids, one or more unsaturated carboxylic anhydrides, or a combination thereof. The binder composition can also include one or more base compounds. The copolymer can also be modified by reaction with one or more base compounds. It has been surprisingly and unexpectedly discovered that the binder compositions discussed and described herein can be used to produce or make lignocellulose based composite products having improved properties as compared to a comparative lignocellulose based composite product having the same aldehyde based resin, but no copolymer. For example, the internal bond strength and/or shear strength of a lignocellulose based composite product produced or made with the binder composition that includes the aldehyde based resin and the copolymer can be greater than the internal bond strength and/or shear strength of the comparative lignocellulose based composite product.

Illustrative unsaturated carboxylic acids can include, but are not limited to, maleic acid, aconitic acid, itaconic acid, acrylic acid, methacrylic acid, crotonic acid, isocrotonic acid, citraconic acid, fumaric acid, polymers thereof, or any combination thereof. Illustrative unsaturated carboxylic anhydrides can include, but are not limited to, maleic anhydride, aconitic anhydride, itaconic anhydride, acrylic anhydride, methacrylic anhydride, crotonic anhydride, isocrotonic anhydride, citraconic anhydride, polymers thereof, or any combination thereof.

The vinyl aromatic derived units can include, but are not limited to, styrene, alpha-methylstyrene, vinyl toluene, or any combination thereof. For example, the vinyl aromatic derived units can be derived from styrene and/or derivatives thereof. In another example, the vinyl aromatic derived units can be derived from styrene. In another example, the vinyl aromatic derived units can be derived from styrene and at least one of alpha-methylstyrene and vinyl toluene.

In at least one example, the copolymer can be or include a copolymer of styrene and maleic anhydride and/or maleic acid (“SMA”). In another example, the copolymer can be or include a copolymer of styrene and acrylic acid. In another example, the copolymer can be or include styrene and polyacrylic acid. In another example, the copolymer can be or include a copolymer of styrene and methacrylic acid. In another example, the copolymer can be or include a copolymer of styrene and itaconic acid. In another example, the copolymer can be or include a terpolymer of one or more vinyl aromatic derived units, e.g., styrene, and two or more of maleic anhydride, maleic acid, acrylic acid, methacrylic acid, and itaconic acid. As such, the term “copolymer,” as used herein, can be or include a terpolymer.

Referring to SMA copolymers in particular, suitable SMA copolymers can have the following generalized formula in the unneutralized form:

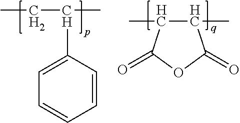

where p and q are positive numbers in a ratio (p:q) that can vary from about 0.5:1.0 to about 5:1.

Unneutralized SMA copolymers can be insoluble in water. Sufficient neutralization of the SMA copolymers in an aqueous environment can solubilize the SMA copolymers. For example, the SMA copolymers can be neutralized in an aqueous environment using an alkaline or basic substance to produce solubilized SMA copolymers. Illustrative alkaline substances can include, but are not limited to, hydroxides such as sodium hydroxide, potassium hydroxide, ammonium hydroxide (e.g., aqueous ammonia), lithium hydroxide, and/or cesium hydroxide; carbonates such as sodium carbonate, potassium carbonate, and/or ammonium carbonate; ammonia and/or an amine (e.g., an alkanolamine). Although it generally is desirable to use the neutralizing agent in an amount sufficient to neutralize 100 mole % (“mol %”) of the SMA copolymer, an amount sufficient to obtain water solubility can be used. The level of addition of any particular neutralizing agent to obtain an acceptable degree of water solubility is well within the normal skill in the art and the product of only routine experimentation. For example, about 10 mol %, about 20 mol %, about 30 mol %, about 40 mol %, about 50 mol %, about 60 mol %, about 70 mol %, about 80 mol %, about 90 mol %, or about 95 mol % of the SMA copolymer can be neutralized. In another example, the amount of neutralization can range from a low of about 40 mol %, about 45 mol %, or about 50 mol % to a high of about 65 mol %, about 75 mol %, or about 90 mol % of the SMA copolymer, with suitable ranges including the combination of any lower amount and any upper amount. As known to those skilled in the art, solubilizing the SMA copolymer can be facilitated at elevated temperature and/or pressure. In at least one example, less than about 10 mol %, less than about 5 mol %, less than about 3 mol %, or less than about 1 mol % of the SMA copolymer can be neutralized. In at least one other example, none of the SMA copolymer can be neutralized.

The molar ratio of the one or more vinyl aromatic derived units to the one or more unsaturated carboxylic acids, one or more unsaturated carboxylic anhydrides, or a combination thereof can widely vary. For example, the one or more unsaturated carboxylic acids, one or more unsaturated carboxylic anhydrides, or any combination thereof can be present in the copolymer in an amount ranging from a low of about 7 mol %, about 10 mol %, about 12 mol %, or about 15 mol % to a high of about 30 mol %, about 35 mol %, about 40 mol %, about 45 mol %, or about 50 mol %, based on the total weight of the one or more unsaturated carboxylic acids, one or more unsaturated carboxylic anhydrides, or any combination thereof and the one or more vinyl aromatic derived units. In another example, the one or more vinyl aromatic derived units can be present in the copolymer in an amount ranging from a low of about 50 mol %, about 55 mol %, about 60 mol %, or about 65 mol % to a high of about 75 mol %, about 80 mol %, about 85 mol %, about 90 mol %, about 93 mol %, or about 95 mol %, based the total weight of the one or more unsaturated carboxylic acids, one or more unsaturated carboxylic anhydrides, or any combination thereof and the one or more vinyl aromatic derived units. In another example, the copolymer can include from about 7 mol % to about 50 mol % of the one or more unsaturated carboxylic acids, one or more unsaturated carboxylic anhydrides, or any combination thereof and conversely from about 50 mol % to about 93 mol % of the one or more vinyl aromatic derived units. In still another example, the copolymer can include from about 20 mol % to about 40 mol % of the one or more unsaturated carboxylic acids, one or more unsaturated carboxylic anhydrides, or any combination thereof and conversely from about 60 mol % to about 80 mol % of the one or more vinyl aromatic derived units.

The molecular weight of the copolymer can vary within wide limits. Preferably, the copolymer has a weight average molecular weight (“Mw”) between about 500 and about 200,000. For example, the copolymer can have a Mw ranging from a low of about 500, about 750, about 1,000, about 1,500, about 2,000, about 2,500, about 3,000, or about 4,000 to a high of about 50,000, about 70,000, about 90,000, about 100,000, about 120,000, about 140,000, about 160,000, or about 180,000, with suitable ranges including the combination of any lower amount and any upper amount. In another example, the copolymer can have a Mw ranging from about 500 to about 60,000, about 1,000 to about 60,000, about 2,000 to about 10,000, about 10,000 to about 80,000, or about 1,500 to about 60,000. In another example, the copolymer can have a Mw ranging from about 500 to about 10,000, about 500 to about 5,000, about 500 to about 3,000, about 1,000 to about 9,000, about 1,500 to about 7,000, or about 2,500 to about 6,000. In another example, the copolymer can have a Mw ranging from about 50,000 to about 90,000, about 70,000 to about 90,000, about 80,000 to about 100,000, about 100,000 to about 140,000, about 110,000 to about 130,000, about 115,000 to about 125,000, or about 105,000 to about 145,000.

The copolymer can include a major amount (greater than 50 mol %, or greater than about 60 mol %, or greater than about 70 mol %, or greater than about 80 mol %, or greater than about 90 mol %, based on the combined amount of unsaturated carboxylic acids and/or unsaturated carboxylic anhydrides) of maleic anhydride and/or maleic acid and a minor amount (less than 50 mol %, or less than about 40 mol %, or less than about 30 mol %, less than about 20 mol %, or less than about 10 mol %, based on the combined amount of the unsaturated carboxylic acids and/or unsaturated carboxylic anhydrides) of the one or more other unsaturated carboxylic acids such as aconitic acid, itaconic acid, acrylic acid, methacrylic acid, crotonic acid, isocrotonic acid, citraconic acid, fumaric acid, or any combination thereof and/or the one or more other unsaturated carboxylic anhydrides such as maleic anhydride, aconitic anhydride, itaconic anhydride, acrylic anhydride, methacrylic anhydride, crotonic anhydride, isocrotonic anhydride, citraconic anhydride, polymers thereof, or any combination thereof. The copolymer can also contain a minor amount (less than 50 mol %, or less than about 40 mol %, or less than about 30 mol %, or less than about 20 mol %, based on the amount of the one or more vinyl aromatic derived units) of another hydrophobic vinyl monomer. Another “hydrophobic vinyl monomer” is a monomer that typically produces, as a homopolymer, a polymer that is water-insoluble or capable of absorbing less than 10% by weight water. Suitable hydrophobic vinyl monomers are exemplified by (i) vinyl esters of aliphatic acids such as vinyl acetate, vinyl propionate, vinyl butyrate, vinyl caproate, vinyl 2-ethylhexanoate, vinyl laurate, and vinyl stearate; (ii) diene monomers such as butadiene and isoprene; (iii) vinyl monomers and halogenated vinyl monomers such as ethylene, propylene, cyclohexene, vinyl chloride and vinylidene chloride; (iv) acrylates and alkyl acrylates, such as methyl acrylate, ethyl acrylate, n-propyl acrylate, isopropyl acrylate, n-butyl acrylate, isobutyl acrylate, tert-butyl acrylate, n-hexyl acrylate, cyclohexyl acrylate, hydroxyethylacrylate, hydroxyethylmethacrylate, and 2-ethylhexyl acrylate; and (v) nitrile monomers such as acrylonitrile and methacrylonitrile, and mixtures thereof.

In at least one example, the copolymer can be SMA. In at least one other example, the copolymer can include at least 10 wt %, at least 20 wt %, at least 30 wt %, at least 40 wt %, at least 50 wt %, at least 60 wt %, at least 70 wt %, at least 80 wt %, at least 90 wt %, at least 95 wt %, or about 100 wt % SMA.

As noted above, the binder composition can also include one or more base compounds. In one example, the one or more base compounds can be mixed, blended, or otherwise combined with the aldehyde based resin and the copolymer to produce the binder composition. In another example, the copolymer can be modified by reaction with the one or more base compounds. The copolymer combined with and/or modified by reaction with the one or more base compounds can be combined with the aldehyde based resin to produce the binder composition.

Illustrative base compounds can include, but are not limited to, amines, amides, hydroxides, carbonates, or any combination thereof. Suitable amines can include, but are not limited to, ammonia, ammonium hydroxide, alkanolamines, polyamines, aromatic amines, and any combination thereof. Illustrative alkanolamines can include, but are not limited to, monoethanolamine (“MEA”), diethanolamine (“DEA”), triethanolamine (“TEA”), or any combination thereof. Preferably, the alkanolamine is a tertiary alkanolamine or more preferably triethanolamine (“TEA”). An alkanolamine is defined as a compound that has both amino and hydroxyl functional groups as illustrated by diethanolamine, triethanolamine, 2-(2-aminoethoxy)ethanol, aminoethyl ethanolamine, aminobutanol and other aminoalkanols. Illustrative aromatic amines can include, but are not limited to, benzyl amine, aniline, ortho toludine, meta toludine, para toludine, n-methyl aniline, N—N′-dimethyl aniline, di- and tri-phenyl amines, 1-naphthylamine, 2-naphthylamine, 4-aminophenol, 3-aminophenol and 2-aminophenol. Illustrative polyamines can include, but are not limited to, diethylenetriamine (“DETA”), triethylenetetramine (“TETA”), tetraethylenepentamine (“TEPA”). Other polyamines can include, for example, 1,3-propanediamine, 1,4-butanediamine, polyamidoamines, and polyethylenimines.

Other suitable amines can include, but are not limited to, primary amines (“NH₂R₁”), secondary amines (“NHR₁R₂”), and tertiary amines (“NR₁R₂R₃”), where each R₁, R₂, and R₃ is independently selected from alkyls, cycloalkyls, heterocycloalkyls, aryls, heteroaryls, and substituted aryls. The alkyl can include branched or unbranched alkyls having from 1 to about 15 carbon atoms or more preferably from 1 to about 8 carbon atoms. Illustrative alkyls can include, but are not limited to, methyl, ethyl, n-propyl, isopropyl, n-butyl, sec butyl, t-butyl, n-pentyl, n-hexyl, and ethylhexyl. The cycloalkyls can include from 3 to 7 carbon atoms. Illustrative cycloalkyls can include, but are not limited to, cyclopentyl, substituted cyclopentyl, cyclohexyl, and substituted cyclohexyl. The term “aryl” refers to an aromatic substituent containing a single aromatic ring or multiple aromatic rings that are fused together, linked covalently, or linked to a common group such as a methylene or ethylene moiety. More specific aryl groups contain one aromatic ring or two or three fused or linked aromatic rings, e.g., phenyl, naphthyl, biphenyl, anthracenyl, phenanthrenyl, and the like. In one or more embodiments, aryl substituents can have from 1 to about 20 carbon atoms. The term “heteroatom-containing,” as in a “heteroatom-containing cycloalkyl group,” refers to a molecule or molecular fragment in which one or more carbon atoms is replaced with an atom other than carbon, e.g., nitrogen, oxygen, sulfur, phosphorus, boron, or silicon. Similarly, the term “heteroaryl” refers to an aryl substituent that is heteroatom-containing. The term “substituted,” as in “substituted aryls,” refers to a molecule or molecular fragment in which at least one hydrogen atom bound to a carbon atom is replaced with one or more substituents that are functional groups such as hydroxyl, alkoxy, alkylthio, phosphino, amino, halo, silyl, and the like. Illustrative primary amines can include, but are not limited to, methylamine and ethylamine. Illustrative secondary amines can include, but are not limited to, dimethylamine and diethylamine. Illustrative tertiary amines can include, but are not limited to, trimethylamine and triethylamine. Illustrative amides can include, but are not limited to, acetamide, ethanamide, dicyandiamide, and the like, or any combination thereof.

Suitable hydroxides can include one or more alkali and/or alkaline earth metal hydroxides and/or carbonates. Illustrative hydroxides can include, but are not limited to, sodium hydroxide, potassium hydroxide, ammonium hydroxide (e.g., aqueous ammonia), lithium hydroxide, cesium hydroxide, barium hydroxide, calcium hydroxide, magnesium hydroxide, aluminum hydroxide, or any combination thereof. Illustrative carbonates can include, but are not limited to, sodium carbonate, sodium bicarbonate, potassium carbonate, and ammonium carbonate.

The copolymer can be combined with and/or modified by reaction with the one or more base compounds in any desired ratio or amount with respect to one another. For example, the amount of the copolymer can range from about 1 wt % to about 99 wt % and conversely the amount of the one or more base compounds can range from about 99 wt % to about 1 wt %, based on the combined weight of the copolymer and the one or more base compounds. In another example, the amount of the copolymer can range from a low of about 5 wt %, about 10 wt %, about 15 wt %, about 20 wt %, about 25 wt % about 30 wt %, about 35 wt %, about 40 wt %, or about 45 wt % to a high of about 60 wt %, about 65 wt %, about 70 wt %, about 75 wt %, about 80 wt %, about 85 wt %, about 90 wt %, or about 95 wt %, based on the combined weight of the copolymer and the one or more base compounds. In another example, the amount of the one or more base compounds can range from a low of about 5 wt %, about 10 wt %, about 15 wt %, about 20 wt %, about 25 wt % about 30 wt %, about 35 wt %, about 40 wt %, or about 45 wt % to a high of about 60 wt %, about 65 wt %, about 70 wt %, about 75 wt %, about 80 wt %, about 85 wt %, about 90 wt %, or about 95 wt %, based on the combined weight of the copolymer and the one or more base compounds. In another example, the amount of the one or more base compounds can range from about 5 wt % to about 45 wt %, or about 10 wt % to about 40 wt %, or about 25 wt % to about 35 wt %, or about 5 wt % to about 15 wt %, based on the combined weight of the copolymer and the one or more base compounds.

If the copolymer is combined with and/or modified by reaction with two or more base compounds, the two or more base compounds can be present in any desired amount or ratio relative to one another. For example, if a first and second base compound are present, the first base compound can be present in an amount ranging from about 1 wt % to about 99 wt %, based on the combined weight of the first and second base compounds. In another example, if the first and second base compounds are present, the first base compound can be present in an amount ranging from a low of about 2 wt %, about 5 wt %, about 15 wt %, or about 25 wt % to a high of about 50 wt %, about 60 wt %, about 70 wt %, or about 90 wt %, based on the combined weight of the first and second base compounds. In another example, if the first and second base compounds are present, the first base compound can be present in an amount ranging from a low of about 2 wt %, about 5 wt %, or about 10 wt % to a high of about 15 wt %, about 25 wt %, about 35 wt %, or about 50 wt %, based on the combined weight of the first and second base compounds. Similarly, if three or more base compounds are present the three or more base compounds can be present in any desired proportion or amount with respect to one another.

In at least one example, the copolymer can be modified by reaction with a mixture of ammonia and at least one of monoethanolamine, diethanolamine, and triethanolamine, where the ammonia can be present in an amount ranging from about 1 wt % to about 99 wt % and conversely the at least one of monoethanolamine, diethanolamine, and triethanolamine can be present in an amount ranging from about 99 wt % to about 1 wt %, based on the combined weight of the ammonia and the at least one of monoethanolamine, diethanolamine, and triethanolamine. In another example, the copolymer can be modified by reaction with a mixture of ammonia and two or more of monoethanolamine, diethanolamine, and triethanolamine. In such a mixture, the ammonia can be present, for example, in an amount ranging from about 10 wt % to about 40 wt %, e.g., about 33 wt %, and the two or more of monoethanolamine, diethanolamine, and triethanolamine can be present in an amount ranging from about 80 wt % to about 60 wt %, e.g., about 67 wt %, based on the combined weight of the ammonia and the two or more of monoethanolamine, diethanolamine, and triethanolamine. In at least one example, if two or more base compounds are reacted with the copolymer and the base compounds include monoethanolamine, the monoethanolamine can be present in an amount less than about 15 wt %, less than about 10 wt %, less than about 7 wt %, less than about 5 wt %, less than about 3 wt %, less than about 1 wt %, or less than about 0.5 wt % monoethanolamine, based on the combined weight of the base compounds. In another example, the first copolymer can be modified by reaction with ammonia, e.g., an aqueous solution of ammonia, where the ammonia can be preset in an amount ranging from about 5 wt % to about 40 wt %, or about 5 wt % to about 15 wt %, or about 10 wt % to about 30 wt %, or about 7 wt % to about 20 wt %, based on the combined weight of the first copolymer and the ammonia. In another example, the copolymer can be modified by reaction with one or more amines other than ammonia. In other words, the copolymer can be free from any intentionally added ammonia. In another example, the copolymer can be modified by reaction with one or more base compounds other than an amine such as one or more hydroxides or carbonates. Said another way, the copolymer can be modified by reaction with one or more hydroxides, carbonates, or a combination thereof, in the absence of any intentionally added amines.

The binder composition that includes the copolymer modified by reaction with the one or more base compounds can have a pH ranging from a low of about 4, about 4.5, about 5, or about 5.5 to a high of about 7, about 8, about 9, or about 10. For example, the binder composition can have a pH of about 5 to about 7, about 5.5 to about 6.5, or about 5.7 to about 6.3. The binder composition that includes the copolymer modified by reaction with the one or more base compounds can have a viscosity ranging from a low of about 50 centipoise (“cP”), about 100 cP, about 200, cP, about 300 cP, about 500 cP, about 750 cP, or about 900 cP to a high of about 1,100 cP, about 1,300 cP, about 1,500 cP, about 1,700 cP, about 2,000 cP, about 2,250 cP, or about 2,500 cP.

The viscosity of any one or more of the aldehyde based resins, the copolymer, and/or the binder compositions discussed and described herein can be determined using a Brookfield Viscometer at a temperature of about 25° C. For example, a Brookfield Viscometer, Model DV-II+, with a small sample adapter with, for example, a number 3 spindle, can be used. The small sample adapter can allow the sample to be cooled or heated by the chamber jacket to maintain the temperature of the sample surrounding the spindle at a temperature of about 25° C.

The copolymer can be reacted with the one or more base compounds at a temperature ranging from a low of about 40° C., about 70° C., or about 90° C. to a high of about 100° C., about 125° C., or about 150° C. The copolymer can be reacted with the one or more base compounds under a pressure ranging from a low of about 50 kPa, about 75 kPa, or about 101 kPa to a high of about 150 kPa, about 300 kPa, or about 500 kPa. The copolymer can be reacted with the one or more base compounds for a time ranging from a low of about 30 minutes, about 45 minutes, or about 1 hour to a high of about 4 hours, about 6 hours, or about 10 hours. In at least one example, the copolymer can be reacted with the one or more base compounds at a temperature ranging from about 85° C. to about 115° C., at atmospheric pressure, and for a time ranging from about 3 hours to about 7 hours.

The copolymer and/or the one or more base compounds can be combined and reacted with one another alone or in the presence of a liquid medium. The liquid medium can be or include one or more polar aprotic solvents, one or more polar protic solvents, or any combination thereof. Illustrative polar aprotic solvents can include, but are not limited to, tetrahydrofuran (“THF”), dimethyl sulfoxide (“DMSO”), N-methylpyrrolidone (“NMP”), dimethyl acetamide, acetone, or any combination thereof. Illustrative polar protic solvents can include, but are not limited to, water, methanol, ethanol, propanol, butanol, or any combination thereof. Other liquid mediums can include ketones such as methyl ethyl ketone. The liquid medium, if present, can be added before, during, and/or after the copolymer is reacted with the one or more base compounds. For example, the copolymer can be reacted with an aqueous base compound, e.g., ammonia and/or sodium hydroxide, and after reaction additional liquid medium which can be the same or different, e.g., ammonia or methanol, can then be added to the copolymer modified by reaction with the base compound.

The amount of the liquid medium combined with the copolymer and the one or more base compounds and/or the copolymer modified by reaction with the one or more base compounds can be sufficient to produce a copolymer having a solids concentration ranging from about 0.1 wt % to about 75 wt %. As used herein, the solids content of the copolymer, base compound, and the like, as understood by those skilled in the art, can be measured by determining the weight loss upon heating a small sample, e.g., 1-5 grams of the copolymer, to a suitable temperature, e.g., 125° C., and a time sufficient to remove the liquid. By measuring the weight of the sample before and after heating, the percent solids in the sample can be directly calculated or otherwise estimated. For example, the amount of liquid medium combined with the copolymer and the one or more base compounds and/or the copolymer modified by reaction with the one or more base compounds can be sufficient to produce a copolymer having a solids concentration ranging from a low of about 1 wt %, about 5 wt %, about 10 wt % or about 15 wt % or about 20 wt % to a high of about 30 wt %, about 40 wt %, about 50 wt %, about 60 wt %, about 70 wt %, or about 75 wt %, based on the total weight of the binder composition. In at least one example, a sufficient amount of water, e.g. fresh water or process water, can be combined with the copolymer and the one or more base compounds to provide a mixture having a solids concentration ranging from about 1 wt % about 65 wt %, about 5 wt % to about 40 wt %, about 10 wt % to about 30 wt %, about 15 wt % to about 45 wt %, about 20 wt % to about 60 wt %, about 45 wt % to about 55 wt %, or about 40 wt % to about 60 wt %, based on the total weight of the binder composition.

The copolymer can be reacted with the one or more base compounds in any device, system, apparatus, or combination of devices, systems, and/or apparatus. For example, the copolymer and the base compound can be mixed, blended, or other wise combined with one another in a reactor vessel or container and allowed to at least partially react to produce the copolymer modified by reaction with the base compounds. The reactor vessel or container can include, but is not limited to, mechanical mixing devices such as mixing blades, ejectors, sonic mixers, or combinations thereof. One or more heating jackets, heating coils, internal heating elements, cooling jacks, cooling coils, internal cooling elements, or the like, can be used to adjust or otherwise control the temperature of the reaction mixture. The reactor vessel can be an open vessel or an enclosed vessel.

The copolymer can be at least partially cured or self-cured as a consequence of cross-linking, esterification reactions between pendant carboxyls and hydroxyl groups on the solubilized (hydrolyzed) modified copolymer chains. The copolymer can further include one or more polyols to increase the crosslink density of the cured copolymer. As used herein, the term “polyol” refers to compounds that contain two or more hydroxyl functional groups. Suitable polyols can include, but are not limited to, ethylene glycol, polyglycerol, diethylene glycol, triethylene glycol, polyethylene oxide (hydroxy terminated), glycerol, pentaerythritol, trimethylol propane, diethanolamine, triethanolamine, ethyl diethanolamine, methyl diethanolamine, sorbitol, monosaccharides, such as glucose and fructose, disaccharides, such as sucrose, and higher polysaccharides such as starch and reduced and/or modified starches, dextrin, maltodextrin, polyvinyl alcohols, hydroxyethylcellulose, resorcinol, catechol, pyrogallol, glycollated ureas, and 1,4-cyclohexane diol, lignin, or any combination thereof.

The one or more polyols can be combined with the copolymer and/or the copolymer reacted with the one or more base compounds to produce a copolymer containing from about 1 wt % to about 50 wt % polyols, based on the combined weight of the polyols and the copolymer and/or the copolymer reacted with the one or more base compounds. For example the one or more polyols can be combined with the copolymer modified by reaction with the one or more base compounds to produce a copolymer having a concentration of the one or more polyols ranging from a low of about 1 wt %, about 5 wt %, about 10 wt %, or about 15 wt % to a high of about 30 wt %, about 40 wt %, or about 45 wt %, based on the combined weight of the copolymer modified by reaction with the one or more base compounds and the one or more polyols. In another example, the copolymer can be free from any intentionally added polyol(s).

The copolymer can be at least partially esterified. For example, an SMA copolymer can be partially esterified and can still contain some anhydride groups. The partial esters of the SMA copolymers can be prepared in conventional manners from alkanols of about 3 to 20 carbon atoms, preferably from hexanol or octanol. The extent of the partial-esterification of the SMA copolymers can range from about 5 to 95%, from about 10% to about 80%, from about 20% to about 50%, or from about 15% to about 40%. The esterification can be effected by simply heating a mixture of the appropriate quantities of the SMA copolymers with the alcohol at elevated temperatures, e.g., from about 100° C. to about 200° C. The benzene ring of the SMA copolymers can be substituted with one or more groups. For example, the benzene ring of the SMA copolymers can contain one or more sulfonate groups.

The aldehyde based resin can include, but is not limited to, one or more urea-aldehyde resins, one or more melamine-aldehyde resins, one or more phenol-aldehyde resins, one or more dihydroxybenzene or “resorcinol”-aldehyde resins, one or more phenol-resorcinol-aldehyde resins, one or more melamine-urea-aldehyde resins, one or more phenol-urea-aldehyde resins, or any combination thereof.

The aldehyde component of the aldehyde based resin can include, but is not limited to, unsubstituted aldehyde compounds and/or substituted aldehyde compounds. For example, suitable aldehyde compounds can be represented by the formula RCHO, wherein R is hydrogen or a hydrocarbon radical. Illustrative hydrocarbon radicals can include from 1 to about 8 carbon atoms. In another example, suitable aldehyde compounds can also include the so-called masked aldehydes or aldehyde equivalents, such as acetals or hemiacetals. Illustrative aldehyde compounds can include, but are not limited to, formaldehyde, paraformaldehyde, acetaldehyde, propionaldehyde, butyraldehyde, furfuraldehyde, benzaldehyde, or any combination thereof. One or more other aldehydes, such as glyoxal can be used in place of or in combination with formaldehyde and/or other aldehydes. In at least one example, the aldehyde compound can include formaldehyde, UFC, or a combination thereof.

The aldehyde compound(s) used to produce the aldehyde based resin can be in any form, e.g., solid, liquid, and/or gas. Considering formaldehyde in particular, the formaldehyde can be or include paraform (solid, polymerized formaldehyde), formalin solutions (aqueous solutions of formaldehyde, sometimes with methanol, in 37 percent, 44 percent, or 50 percent formaldehyde concentrations), Urea-Formaldehyde Concentrate (“UFC”), and/or formaldehyde gas in lieu of or in addition to other forms of formaldehyde can also be used. In another example, the aldehyde can be or include a pre-reacted urea-formaldehyde mixture having a urea to formaldehyde weight ratio of about 1:2 to about 1:3.

Suitable urea-formaldehyde resins that can be used as the aldehyde based resin can be prepared from urea and formaldehyde monomers or from urea-formaldehyde precondensates in manners well known to those skilled in the art. Similarly, melamine-formaldehyde, phenol-formaldehyde, and resorcinol-formaldehyde resins can be prepared from melamine, phenol, and resorcinol monomers, respectively, and formaldehyde monomers or from melamine-formaldehyde, phenol-formaldehyde, and resorcinol-formaldehyde precondensates. Urea, phenol, melamine, resorcinol, and formaldehyde reactants are commercially available in many forms and any form that can react with the other reactants and does not introduce extraneous moieties deleterious to the desired reaction and reaction product can be used in the preparation of the second copolymer. One particularly useful class of urea-formaldehyde resins can be as discussed and described in U.S. Pat. No. 5,362,842.

Similar to formaldehyde, urea, phenol, resorcinol, and melamine are available in many forms. For example, with regard to urea, if present in the aldehyde based resin, solid urea, such as prill and urea solutions, typically aqueous solutions, are can be used. Further, urea may be combined with another moiety, most typically formaldehyde and urea-formaldehyde adducts, often in aqueous solution. Any form of urea or urea in combination with formaldehyde can be used to make a urea-formaldehyde resin. Both urea prill and combined urea-formaldehyde products are preferred, such as UFC. These types of products can be as discussed and described in U.S. Pat. Nos. 5,362,842 and 5,389,716, for example.

Urea-formaldehyde resins can include from about 45% to about 70%, and preferably, from about 55% to about 65% non-volatiles, generally have a viscosity of about 50 cP to about 2,500 or about 100 cP to about 1,500 cP, normally exhibit a pH of about 7 to about 9, preferably about 7.5 to about 8.5, and often have a free formaldehyde level of not more than about 3.0%, and a water dilutability of about 1:1 to about 100:1, preferably about 5:1 and above.

Melamine, if present in the aldehyde based resin, can also be provided in many forms. For example, solid melamine, such as prill and/or melamine solutions can be used. Although melamine is specifically referred to, the melamine can be totally or partially replaced with other aminotriazine compounds. Other suitable aminotriazine compounds can include, but are not limited to, substituted melamines, cycloaliphatic guanamines, or combinations thereof. Substituted melamines include the alkyl melamines and aryl melamines that can be mono-, di-, or tri-substituted. In the alkyl substituted melamines, each alkyl group can contain 1-6 carbon atoms and, preferably 1-4 carbon atoms. Illustrative examples of the alkyl-substituted melamines can include, but are not limited to, monomethyl melamine, dimethyl melamine, trimethyl melamine, monoethyl melamine, and 1-methyl-3-propyl-5-butyl melamine. In the aryl-substituted melamines, each aryl group can contain 1-2 phenyl radicals and, preferably, one phenyl radical. Illustrative examples of aryl-substituted melamines can include, but are not limited to, monophenyl melamine and diphenyl melamine. Any of the cycloaliphatic guanamines can also be used. Suitable cycloaliphatic guanamines can include those having 15 or less carbon atoms. Illustrative cycloaliphatic guanamines can include, but are not limited to, tetrahydrobenzoguanamine, hexahydrobenzoguanamine, 3-methyl-tetrahydrobenzo guanamine, 3-methylhexahydrobenzoguanamine, 3,4-dimethyl-1,2,5,6-tetrahydrobenzoguanamine, and 3,4-dimethylhexahydrobenzoguanamine and mixtures thereof. Mixtures of aminotriazine compounds can include, for example, melamine and an alkyl-substituted melamine, such as dimethyl melamine, or melamine and a cycloaliphatic guanamine, such as tetrahydrobenzoguanamine.

The phenol component, if present in the aldehyde based resin, can include a variety of substituted phenolic compounds, unsubstituted phenolic compounds, or any combination of substituted and/or unsubstituted phenolic compounds. For example, the phenol component can be phenol itself (i.e., mono-hydroxy benzene). Examples of substituted phenols can include, but are not limited to, alkyl-substituted phenols such as the cresols and xylenols; cycloalkyl-substituted phenols such as cyclohexyl phenol; alkenyl-substituted phenols; aryl-substituted phenols such as p-phenyl phenol; alkoxy-substituted phenols such as 3,5-dimethyoxyphenol; aryloxy phenols such as p-phenoxy phenol; and halogen-substituted phenols such as p-chlorophenol. Dihydric phenols such as catechol, resorcinol, hydroquinone, bisphenol A and bisphenol F also can also be used. In particular, the phenol component can be selected from the group consisting of phenol; alkyl-substituted phenols such as the cresols and xylenols; cycloalkyl-substituted phenols such as cyclohexyl phenol; alkenyl-substituted phenols; aryl-substituted phenols such as p-phenyl phenol; alkoxy-substituted phenols such as 3,5-dimethyoxyphenol; aryloxy phenols such as p-phenoxy phenol; halogen-substituted phenols such as p-chlorophenol; catechol, hydroquinone, bisphenol A and bisphenol F. Preferably, about 95 wt % or more of the phenol component comprises phenol (monohydroxybenzene). In at least one example, the aldehyde based resin in the binder composition can be a phenol-aldehyde resin. In at least one example, the aldehyde based resin can be a phenol-formaldehyde resin. In at least one example, the binder composition can be a mixture or combination of a phenol-aldehyde resin and SMA. In at least one other example, the binder composition can be a mixture or combination of a phenol-formaldehyde resin and SMA.

Suitable phenol-aldehyde resins, e.g., phenol-formaldehyde, can have a molar ratio of aldehyde to phenol (A:P) ranging from a low of about 1.7, about 1.8, or about 1.9 to a high of about 2.5, about 2.6, or about 2.7. For example, suitable phenol-aldehyde resins can have a molar ratio of aldehyde to phenol ranging from about 1.8 to about 2.6, about 2.1 to about 2.6, about 2.2 to about 2.5, about 2.3 to about 2.5, about 2.4 to about 2.5, about 2.45 to about 2.5, or about 2.05 to about 2.55. Suitable phenol-aldehyde resins, e.g., phenol-formaldehyde, can have a pH ranging from a low of about 7, about 8, or about 9 to a high of about 11, about 12, or about 13.

The resorcinol component, if present in the aldehyde based resin, can be provided in a variety of forms. For example, the resorcinol component can be provided as a white/off-white solid or flake and/or the resorcinol component can be heated and supplied as a liquid. Any form of the resorcinol can be used with any form of the aldehyde component to make the resorcinol-aldehyde copolymer. The resorcinol component can be resorcinol itself (i.e., Benzene-1,3-diol). Suitable resorcinol compounds can also be described as substituted phenols. The solids component of a liquid resorcinol-formaldehyde copolymer can range from about 45 wt % to about 75 wt %. Liquid resorcinol-formaldehyde copolymers can have a viscosity that varies widely, e.g., from about 200 cP to about 20,000 cP. Liquid resorcinol copolymers typically have a dark amber color.

Many suitable aldehyde based resins are commercially available. For example, suitable aldehyde based resins can include, but are not limited to, resins sold by Georgia-Pacific Chemicals LLC (e.g., LEAF™, RESI-STRAN®, REST-BOND®, WOODWELD®, RESORSABOND®, and REST-MIX®. These aldehyde based resins can be prepared in accordance with well known methods and contain reactive methylol groups which upon curing form methylene or ether linkages. Such methylol-containing adducts may include N,N′-dimethylol, dihydroxymethylolethylene; N,N′ bis(methoxymethyl), N,N′-dimethylolpropylene; 5,5-dimethyl-N,N′ dimethylolethylene; N,N′-dimethylolethylene; and the like.

The aldehyde based resin and the copolymer can be combined with one another any desired amount to produce the binder composition. For example, the aldehyde based resin can be present in the binder composition in an amount ranging from about 0.1 wt % to about 99.9 wt %, based on the total solids weight of the aldehyde based resin and the copolymer. In another example, the aldehyde based resin can be present in an amount ranging from a low of about 1 wt %, about 5 wt %, about 10 wt %, about 15 wt %, about 20 wt %, about 25 wt % about 30 wt %, about 35 wt %, about 40 wt %, or about 45 wt % to a high of about 60 wt %, about 65 wt %, about 70 wt %, about 75 wt %, about 80 wt %, about 85 wt %, about 90 wt %, about 95 wt %, or about 99 wt %, based on the total solids weight of the copolymer and the aldehyde based resin. In another example, the copolymer can be present in the binder composition in an amount ranging from a low of about 1 wt %, about 5 wt %, about 10 wt %, about 15 wt %, about 20 wt %, about 25 wt % about 30 wt %, about 35 wt %, about 40 wt %, or about 45 wt % to a high of about 60 wt %, about 65 wt %, about 70 wt %, about 75 wt %, about 80 wt %, about 85 wt %, about 90 wt %, about 95 wt %, or about 99 wt %, based on the total solids weight of the copolymer and the aldehyde based resin. In another example, the binder composition can include about 1 wt % to about 99 wt %, or about 1 wt % to about 15 wt %, or about 15 wt % to about 35 wt %, or about 35 wt % to about 65 wt %, or about 65 wt % about 95 wt %, or about 85 wt % to about 99 wt %, or about 45 wt % to about 55 wt % of the copolymer, based on the total solids weight of the copolymer and the aldehyde based resin. In another example, the binder composition can include about 5 wt % copolymer and about 95 wt % aldehyde based resin, or about 10 wt % copolymer and about 90 wt % aldehyde based resin, or about 20 wt % copolymer and about 80 wt % aldehyde based resin, or about 25 wt % copolymer and about 75 wt % aldehyde based resin, or about 30 wt % copolymer and about 70 wt % aldehyde based resin, or about 40 wt % copolymer and about 60 wt % aldehyde based resin, or about 50 wt % copolymer and about 50 wt % aldehyde based resin, or about 60 wt % copolymer and about 40 wt % aldehyde based resin, or about 70 wt % copolymer and about 30 wt % aldehyde based resin, or about 75 wt % copolymer and about 25 wt % aldehyde based resin, or about 80 wt % copolymer and about 20 wt % aldehyde based resin, or about 90 wt % copolymer and about 10 wt % aldehyde based resin, or about 95 wt % copolymer and about 5 wt % aldehyde based resin, based on the total solids weight of the copolymer and the aldehyde based resin.

In at least one example, the copolymer can be present in the binder composition in an amount ranging from about 0.1 wt % to about 30 wt %, about 0.1 wt % to about 25 wt %, about 0.1 wt % to about 20 wt %, or about 0.1 wt % to about 15 wt %, based on the total solids weight of the aldehyde based resin and the copolymer. In another example, the copolymer can be present in the binder composition in an amount ranging from a low of about 0.1 wt %, about 0.5 wt %, about 1 wt %, or about 2 wt % to a high of about 7 wt %, about 10 wt %, about 12 wt %, or about 14 wt %, based on the total solids weight of the aldehyde based resin and the copolymer. In another example, the copolymer can be present in the binder composition in an amount of at least 0.1 wt %, at least 1 wt %, at least 2 wt %, at least 3 wt %, at least 5 wt %, at least 7 wt %, or at least 9 wt %, based on the total solids weight of the aldehyde based resin and the copolymer. In another example, the copolymer can be present in the binder composition in an amount ranging from about 1 wt % to about 10 wt %, about 0.5 wt % to about 4 wt %, about 2 wt % to about 7 wt %, or about 0.5 wt % to about 3 wt %, based on the total solids weight of the aldehyde based resin and the copolymer.

In one example, the binder composition can include from about 85 wt % to about 99.9 wt % of the aldehyde based resin and from about 0.1 wt % to about 15 wt % of the copolymer, based on the total solids weight of the aldehyde based resin and the copolymer. In another example, the binder composition can include from about 90 wt % to about 99 wt % of the aldehyde based resin and from about 1 wt % to about 10 wt % of the copolymer, based on the total solids weight of the aldehyde based resin and the copolymer. In another example, the binder composition can include from about 93 wt % to about 99.5 wt % of the aldehyde based resin and from about 0.5 wt % to about 7 wt % of the copolymer, based on the total solids weight of the aldehyde based resin and the copolymer. In another example, the binder composition can include from about 95 wt % to about 99.5 wt % of the aldehyde based resin and from about 0.5 wt % to about 5 wt % of the copolymer, based on the total solids weight of the aldehyde based resin and the copolymer. In another example, the binder composition can include from about 96 wt % to about 99.5 wt % of the aldehyde based resin and from about 0.5 wt % to about 4 wt % of the copolymer, based on the total solids weight of the aldehyde based resin and the copolymer. In another example, the binder composition can include from about 97 wt % to about 99.5 wt % of the aldehyde based resin and from about 0.5 wt % to about 3 wt % of the copolymer, based on the total solids weight of the aldehyde based resin and the copolymer.

The binder composition can have a viscosity ranging from a low of about 50 cP, about 75 cP, about 100 cP, about 150 cP, about 300 cP, or about 500 cP to a high of about 1,000 cP, about 2,000 cP, about 3,000 cP, about 4,000 cP, about 5,000 cP, or about 6,000 cP. For example, the viscosity of the binder composition can range from about 85 cP to about 1,150 cP, about 100 cP to about 1,050 cP, about 100 cP to about 1,000 cP, or about 300 cP to about 800 cP. The viscosity can be measured using a Brookfield LVF viscometer with a number 3 spindle at a temperature of about 25° C.

The binder composition can have a pH ranging from a low of about 6, about 7, or about 8 to a high of about 10, about 11, about 12, or about 13. The particular pH of the binder composition can be based on, at least in part, the particular aldehyde based resin, the particular copolymer, and/or the relative amounts of the aldehyde based resin and the copolymer to one another in the binder composition.

The pH of the binder composition can be adjusted to a desired pH by adding a sufficient amount of one or more base compounds and/or one or more acid compounds thereto. Illustrative base compounds that can be used to adjust the pH of the binder composition can include, but are not limited to, hydroxides, carbonates, ammonia, amines, amides, or any combination thereof. Illustrative hydroxides can include, but are not limited to, sodium hydroxide, potassium hydroxide, ammonium hydroxide (e.g., aqueous ammonia), lithium hydroxide, and cesium hydroxide. Illustrative carbonates can include, but are not limited to, sodium carbonate, sodium bicarbonate, potassium carbonate, and ammonium carbonate. Illustrative amines can include, but are not limited to, trimethylamine, triethylamine, triethanolamine, diisopropylethylamine (Hunig's base), pyridine, 4-dimethylaminopyridine (DMAP), and 1,4-diazabicyclo[2.2.2]octane (DABCO). Illustrative acid compounds that can be used to adjust the pH of the binder composition can include, but are not limited to, one or more mineral acids, one or more organic acids, one or more acid salts, or any combination thereof. Illustrative mineral acids can include, but are not limited to, hydrochloric acid, nitric acid, phosphoric acid, sulfuric acid, or any combination thereof. Illustrative organic acids can include, but are not limited to, acetic acid, formic acid, citric acid, oxalic acid, uric acid, lactic acid, or any combination thereof. Illustrative acid salts can include, but are not limited to, ammonium sulfate, sodium bicarbonate, sodium hydrosulfide, sodium bisulfate, sodium metabisulfite, or any combination thereof.

The binder composition can be produced as a liquid binder and/or can be combined with a liquid medium. For example, preparation or synthesis of the aldehyde based resin and/or the copolymer can be carried out under conditions that produce a liquid aldehyde based resin and/or a liquid copolymer. In another example, the aldehyde based resin and the copolymer can be separately combined with a liquid medium and then combined with one another to produce the binder composition. In another example, the aldehyde based resin and the copolymer can be combined with one another to produce the binder composition and a liquid medium can then be added to the binder composition. Illustrative liquid mediums can include, but are not limited to, water, alcohols, glycols, acetonitrile, or any combination thereof. Suitable alcohols can include, but are not limited to, methanol, ethanol, propanol, butanol, or any combination thereof. Suitable glycols can include, but are not limited to, ethylene glycol, propylene glycol, or a combination thereof. As used herein, the terms “aqueous medium” and “aqueous liquid” can be or include water and/or mixtures composed of water and/or other water-miscible solvents. Illustrative water-miscible solvents can include, but are not limited to, alcohols, ethers, amines, other polar aprotic solvents, and the like.

The aldehyde based resin, the copolymer, and/or the binder composition containing the aldehyde based resin and the copolymer combined with a liquid medium can have a total concentration of solids ranging from about 1 wt % to about 99 wt %, based on the combined weight of the liquid medium and the aldehyde based resin and/or the copolymer. For example, the aldehyde based resin combined with a liquid medium can have a concentration of solids ranging from a low of about 5 wt %, about 10 wt %, about 15 wt %, or about 20 wt % to a high of about 40 wt %, about 50 wt %, about 60 wt %, about 70 wt %, or about 80 wt %, based on the combined weight of the aldehyde based resin and the liquid medium. Similarly, the copolymer with a liquid medium can have a concentration of solids ranging from a low of about 5 wt %, about 10 wt %, about 15 wt %, or about 20 wt % to a high of about 40 wt %, about 50 wt %, about 60 wt %, about 70 wt %, or about 80 wt %, based on the combined weight of the liquid medium and the copolymer. The binder composition combined with a liquid medium can also have a concentration of solids ranging from a low of about 5 wt %, about 10 wt %, about 15 wt %, or about 20 wt % to a high of about 40 wt %, about 50 wt %, about 60 wt %, about 70 wt %, or about 80 wt %, based on the combined weight of the aldehyde based resin, copolymer, and liquid medium.

As used herein, the solids content of the aldehyde based resin, the copolymer, and the binder composition, as understood by those skilled in the art, can be measured by determining the weight loss upon heating a small sample, e.g., 1-5 grams of the aldehyde based resin, the copolymer, or the binder composition, to a suitable temperature, e.g., 125° C., and a time sufficient to remove the liquid. By measuring the weight of the sample before and after heating, the percent solids in the sample can be directly calculated or otherwise estimated

The binder composition or the aldehyde based resin or the copolymer can be a solid. For example the binder composition can in the form of a powder prepared using any suitable process or combination of processes. For example, the powdered binder composition can be prepared by spray drying, freeze drying, vacuum drying, precipitation, air drying, and/or dry spinning. For example, a liquid, e.g., aqueous, binder composition suitable for spray-drying can have an initial solids concentration ranging from a low of about 10 wt %, about 15 wt %, about 20 wt %, about 25 wt %, or about 30 wt % to a high of about 40 wt %, about 45 wt %, about 50 wt %, about 55 wt %, about 60 wt %, or about 65 wt %, based on the weight of the aqueous binder composition.

Methods for spray-drying, freeze drying, vacuum drying, precipitation, air drying, and dry spinning a liquid binder to produce a powdered binder are well known to those skilled in the art and a detailed description of the equipment and process variables are unnecessary. For example, spray drying refers to the process of atomizing (in the form of small droplets) the liquid binder into a gas stream (often a heated air stream) under controlled temperature conditions and under specific gas/liquid contacting conditions to effect evaporation of liquid from the atomized droplets and production of a dry particulate solid product.

In the spray drying process, a liquid resin, such as an aqueous aldehyde based resin, as-synthesized or after further dilution, can be atomized to small droplets and mixed with hot air (e.g., air at an inlet temperature usually between about 140° C. and about 250° C.) to evaporate the liquid from the resin droplets. The temperature of the resin during the spray-drying process is usually close to or greater than the boiling temperature of the liquid, e.g., the water. An outlet air temperature of between about 60° C. and about 120° C. is common. Due to the curable (thermosetting) character of the resin, adjusting the operation of the spray-drying process to achieve thorough evaporation of the moisture at the lowest possible inlet and outlet temperatures is generally desired.

Spray drying is typically carried out with pressure nozzles (nozzle atomization—including two fluid nozzles) or centrifugal or rotary atomizers operating at high speeds (e.g., a spinning disc). Despite the high velocity generation of droplets, a spray dryer is designed so that the droplets avoid, as much as possible, contact with the spray dryer wall under proper operating procedures. This effect is achieved by a precise balance of atomizer velocity, air flow, spray dryer dimensions, e.g., height and diameter, and the design of inlet and outlet means to produce a cyclonic flow of gas, e.g., air in the chamber. A pulse atomizer also can be used to produce the small droplets needed to facilitate evaporation of the water. In some cases, it can be desirable to include a flow promoter, such as calcium stearate and/or an aluminosilicate material, in the aqueous dispersion that is processed in a spray dryer simply to facilitate subsequent handling and transport of the spray dried powder (e.g., to avoid clumping).

The particle size and liquid, e.g., moisture, content of the spray dried powdered resin (and accordingly the bulk density of the powder) is a function of the air feed rate and temperature, liquid feed rate and temperature, liquid droplet size and the solids concentration of the feed liquid. The spray-dried powder can have a liquid, e.g., moisture, content of less than about 10 wt %, less than about 8 wt %, less than about 6 wt %, less than about 4 wt %, less than about 3 wt %, less than about 2 wt %, or less than about 1 wt %. Usually, the liquid, e.g., moisture, content of the spray-dried powder is less than 6 wt %.

The particle size distribution, moisture (or liquid) content, and bulk density of the spray dried resin can be controlled by operations well known in the spray drying art by variables such as feed resin solids content of the aqueous mixture, surface tension, speed of the rotary atomizer, feed rate of the liquid resin, and the temperature differences between the inlet and outlet (atomization gas temperature). Particle size distribution may be an important factor in production of a powdered resin. The powdered resin can have a particle size ranging from about 0.1 μm to about 100 μm. For example, the particle size of the powdered resin can range from a low of about 1 μm, about 5 μm, about 10 μm, or about 20 μm to a high of about 45 μm, about 60 μm, about 70 μm, or about 80 μm. In another example, about 80 wt % to about 90 wt % of the powdered resin can have a particle size of less than about 100 μm, less than about 85 μm, or less than about 75 μm. In another example, about 60 wt % to about 70 wt % of the powdered resin can have a particle size of less than about 60 μm, less than about 50 μm, or less than about 45 μm.

If a desired particle size is not produced directly by the technique used to produce the powdered resin, additional mechanical grinding can be employed to reduce the distribution of the particle sizes further.

In one example, the binder composition can include a powdered aldehyde based resin and an aqueous copolymer. In another example, the binder composition can include an aqueous aldehyde based resin and a powdered copolymer. In another example, the binder composition can include a powdered aldehyde based resin and a powdered copolymer. In another example, the binder composition can include a liquid aldehyde based resin and a liquid copolymer. In another example, the binder composition can include an aqueous aldehyde based resin and an aqueous copolymer

Preparing a binder composition containing a powdered component (e.g., a powdered aldehyde based resin or a powdered copolymer) with the other component being in a liquid, e.g., aqueous, form can include mixing, blending, or otherwise combining the powdered component into the liquid component. In another example, the binder composition can be prepared by mixing, blending, or otherwise combining the liquid component into the powdered component. The blending or mixing procedure can be carried out at ambient temperature or at a temperature greater than ambient temperature, for example about 50° C. The binder composition can be used immediately or stored for a period of time and may be diluted with water to a concentration suitable for the desired method of application. If stored for a period of time, the binder composition can be continuously or periodically agitated or stirred.

The powdered component and the liquid component can be combined in any desired amount with respect to one another to form a two phase binder composition. For example, the amount of the powdered component in the binder composition can range from about 0.1 wt % to about 99.9 wt %, based on the combined weight of the powdered component and the weight of the solids in the liquid component. For example, the binder composition can have a concentration of the powdered component in an amount ranging from a low of about 0.5 wt %, about 1 wt %, about 2 wt %, about 3 wt %, or about 4 wt % to a high of about 10 wt %, about 20 wt %, about 30 wt %, about 40 wt %, about 50 wt %, about 60 wt %, about 70 wt %, about 80 wt %, or about 90 wt %, based on the combined weight of the powdered component and the weight of solids in the liquid component. In another example, the binder composition can have a concentration of the powdered component in an amount ranging from about 1 wt % to about 10 wt %, about 3 wt % to about 25 wt %, about 0.5 wt % to about 45 wt %, or about 2 wt % to about 35 wt %, based on the combined weight of the powdered component and the weight of the solids in the liquid component.

A binder composition that includes both a powdered component and a liquid component can have a total concentration of solids, i.e. the combination of the powdered component and the solids in the liquid component, ranging from about 0.1 wt % to about 90 wt %, based on a combined weight of the liquid component and the powdered component. For example, the binder composition can have a concentration of solids ranging from a low of about 0.1 wt %, about 1 wt %, about 5 wt %, or about 10 wt % to a high of about 20 wt %, about 30 wt %, about 40 wt %, about 50 wt %, or about 60 wt %, based on the combined weight of the liquid component and the powdered component. In another example, the binder composition can have a concentration of solids ranging from about 1 wt % to about 45 wt %, about 5 wt % to about 40 wt %, about 10 wt % to about 35 wt %, about 5 wt % to about 30 wt %, or about 15 wt % to about 30 wt %, based on the combined weight of the liquid component and the powdered component.

The binder compositions discussed and described herein can be used to make, produce, or otherwise prepare a variety of products. For example, the binder composition can be applied to a plurality of lignocellulose substrates, which can be formed into a desired shape before or after application of the binder composition, and the binder composition can be at least partially cured to produce a lignocellulose based composite product. At least partially curing the binder composition can include applying heat and/or pressure thereto. The binder composition can also at least partially cure at room temperature and pressure. In another example, the binder composition can be applied to a plurality of lignocellulose or wood particles and at least partially cured to produce cellulose based or wood based products or composites. In another example, the binder composition can be applied to a wood or other lignocellulose based veneers and/or substrates and the binder composition can be at least partially cured to adhere the veneer(s) and/or substrate(s) to one another. In another example, a binder composition can be applied to a plurality randomly oriented lignocellulose fibers, formed into a mat or board, and then at least partially cured to produce a lignocellulose mat or board.

The lignocellulose substrates can be contacted with the binder composition by spraying, coating, mixing, brushing, falling film or curtain coater, dipping, soaking, or the like. The lignocellulose substrates contacted with the binder composition can be formed into a desired shape before, during, and/or after at least partial curing of the binder composition. Depending on the particular product, the lignocellulose substrates contacted with the binder composition can be pressed before, during, and/or after the binder composition is at least partially cured. For example, the lignocellulose substrates contacted with the binder composition can be consolidated or otherwise formed into a desired shape, if desired pressed to a particular density and thickness, and heated to at least partially cure the binder composition. In another example, a blended furnish, i.e., a mixture of the lignocellulose substrates and the binder composition, can be extruded through a die (extrusion process) and heated to at least partially cure the binder composition.

As used herein, the terms “curing,” “cured,” and similar terms are intended to refer to the structural and/or morphological change that occurs in the binder composition as it is cured to cause covalent chemical reaction (crosslinking), ionic interaction or clustering, improved adhesion to the substrate, phase transformation or inversion, and/or hydrogen bonding. As used herein, the phrases “at least partially cure,” “at least partially cured,” and similar terms are intended to refer to a binder composition that has undergone at least some covalent chemical reaction (crosslinking), ionic interaction or clustering, improved adhesion to the substrate, phase transformation or inversion, and/or hydrogen bonding, but may also be capable of undergoing additional covalent chemical reaction (crosslinking), ionic interaction or clustering, improved adhesion to the substrate, phase transformation or inversion, and/or hydrogen bonding.

The pressure applied to the furnish can depend, at least in part, on the particular product. For example, the amount of pressure applied in a particleboard production process can range from about 1 MPa to about 5 MPa or from about 2 MPa to about 4 MPa. In another example, the amount of pressure applied in a MDF production process can range from about 2 MPa to about 7 MPa or from about 3 MPa to about 6 MPa. The temperature the product can be heated to produce an at least partially cured product can range from a low of about 100° C., about 125° C., about 150° C., or about 170° C. to a high of about 180° C., about 200° C., about 220° C., or about 250° C. The length of time the pressure can be applied can range from a low of about 15 second, about 30 seconds, about 1 minute, about 3 minutes, about 5 minutes, or about 7 minutes to a high of about 10 minutes, about 15 minutes, about 20 minutes, or about 30 minutes, which can depend, at least in part, on the particular product and/or the particular dimensions, e.g., thickness of the product. For example, the length of time the pressure and/or heat can be applied to the furnish can range from about 30 seconds to about 2 minutes, about 1 minute to about 3 minutes, about 1.5 minutes to about 4 minutes, or about 45 seconds to about 3.5 minutes.

The amount of the binder composition applied to the lignocellulose substrates can range from a low of about 1 wt %, about 2 wt %, about 3 wt %, about 4 wt %, about 5 wt % or about 6 wt % to a high of about 10 wt %, about 12 wt %, about 15 wt %, or about 20 wt %, based on dry a weight of the lignocellulose substrates, with suitable ranges including the combination of any lower amount and any upper amount. For example, a lignocellulose based composite product can contain from about 5 wt % to about 15 wt %, about 8 wt % to about 14 wt %, about 10 wt % to about 12 wt %, or about 7 wt % to about 10 wt % binder composition, based on a dry weight of the lignocellulose substrates. In another example, a lignocellulose based composite product can contain from about 1 wt % to about 4 wt %, about 1.5 wt % to about 5 wt %, about 2 wt % to about 4 wt %, about 2 wt % to about 6 wt %, or about 0.5 wt % to about 5.5 wt % binder composition, based on a dry weight of the lignocellulose substrates.

Lignocellulose based composite products produced with the binder compositions discussed and described herein can have an internal bond strength that is greater relative to a comparative lignocellulose based composite product produced under the same conditions but with a binder composition free of the copolymer. For example, a lignocellulose based composite product such as a composite panel produced with the binder compositions discussed and described herein can have an internal bond strength that is greater relative to a comparative lignocellulose based composite product produced under the same conditions, but with a binder composition free of the copolymer, in an amount of about 1% or more, about 3% or more, about 5% or more, about 7% or more, about 10% or more about 15% or more about 20% or more, about 25% or more, about 30% or more, about 35% or more, about 40% or more, or about 45% or more. In another example, a lignocellulose based composite product such as a composite panel produced with the binder compositions discussed and described herein can have an internal bond strength that is greater relative to a comparative lignocellulose based composite product produced under the same conditions but with a binder composition free of the copolymer in an amount ranging from a low of about 1%, about 3%, about 5%, about 8%, about 10%, or about 12% to a high of about 15%, about 20%, about 25%, about 30%, about 35%, about 40%, about 45%, or about 50%, with suitable ranges including the combination of any lower amount and any upper amount.

Lignocellulose based composite products such as multi-layer composite panels produced with the binder compositions discussed and described herein can have an internal bond strength that is greater relative to a comparative multi-layer lignocellulose based composite panel produced under the same conditions but with a binder composition free of the copolymer. For example, a multi-layer lignocellulose based composite panel, e.g., having a core layer and two surfaces layers, produced with the binder compositions discussed and described herein can have an internal bond strength that is greater relative to a comparative lignocellulose based composite product produced under the same conditions but with a binder composition free of the copolymer in an amount ranging from a low of about 1%, about 3%, about 5%, about 8%, about 10%, or about 12% to a high of about 15%, about 20%, about 25%, about 30%, about 35%, about 40%, about 45%, or about 50%, with suitable ranges including the combination of any lower amount and any upper amount.

Lignocellulose based composite products produced with the binder compositions discussed and described herein can have a shear strength that is greater relative to a comparative lignocellulose based composite product produced under the same conditions but with a binder composition free of the copolymer. For example, a lignocellulose based composite product such as two strips of wood adhered together with the binder compositions discussed and described herein can have a shear strength that is greater relative to a comparative lignocellulose based composite product produced under the same conditions, but with a binder composition free of the copolymer, in an amount of about 1% or more, about 3% or more, about 5% or more, about 7% or more, about 10% or more about 15% or more about 20% or more, about 25% or more, about 30% or more, about 35% or more, about 40% or more, about 45% or more, about 50% or more, about 55% or more, about 60% or more, about 65% or more, about 70% or more, about 75% or more, or about 80% or more. In another example, a lignocellulose based composite product such as two strips of wood adhered together with the binder compositions discussed and described herein can have a shear strength that is greater relative to a comparative lignocellulose based composite product produced under the same conditions but with a binder composition free of the copolymer in an amount ranging from a low of about 1%, about 3%, about 5%, about 8%, about 10%, or about 12% to a high of about 15%, about 20%, about 25%, about 30%, about 35%, about 40%, about 45%, or about 50%, with suitable ranges including the combination of any lower amount and any upper amount.

The lignocellulose substrates (material that includes both cellulose and lignin) can include, but is not limited to, straw, hemp, sisal, cotton stalk, wheat, bamboo, sabai grass, rice straw, banana leaves, paper mulberry (i.e., bast fiber), abaca leaves, pineapple leaves, esparto grass leaves, fibers from the genus Hesperaloe in the family Agavaceae jute, salt water reeds, palm fronds, flax, ground nut shells, hardwoods, softwoods, recycled fiberboards such as high density fiberboard, medium density fiberboard, low density fiberboard, oriented strand board, particleboard, animal fibers (e.g., wool, hair), recycled paper products (e.g., newspapers, cardboard, cereal boxes, and magazines), or any combination thereof. Suitable woods can include softwoods and/or hardwoods. Illustrative types of wood can include, but are not limited to, alder, ash, aspen, basswood, beech, birch, cedar, cherry, cottonwood, cypress, elm, fir, gum, hackberry, hickory, maple, oak, pecan, pine, poplar, redwood, sassafras, spruce, sycamore, walnut, and willow.

The starting material, from which the lignocellulose substrates can be derived from, can be reduced to the appropriate size or dimensions by various processes such as hogging, grinding, hammer milling, tearing, shredding, and/or flaking. Suitable forms of the lignocellulose substrates can include, but are not limited to, chips, flakes, wafers, fibers, shavings, sawdust or dust, or the like. The lignocellulose substrates can have a length ranging from a low of about 0.05 mm, about 0.1 mm, about 0.2 mm to a high of about 1 mm, about 5 mm, about 10 mm, about 20 mm, about 30 mm, about 40 mm, about 50 mm, or about 100 mm.

The starting material, from which the lignocellulose substrates can be derived from, can also be formed into the appropriate size or dimensions by skiving, cutting, slicing, sawing, or otherwise removing a thin layer or sheet from a source of lignocellulose material, e.g., a wood log, to produce a veneer or layer. One or more lignocellulose based composite products can be produced from two or more veneer. For example, lignocellulose based composite products produced with veneer, in finished form, can include those products typically referred to as laminated veneer lumber (“LVL”), laminated veneer boards (“LVB”), and/or plywood. As such, suitable lignocellulose substrates can include, but are not limited to, wood chips, wood fibers, wood flakes, wood strands, wood wafers, wood shavings, wood particles, wood veneer, or any combination thereof.

Depending, at least in part, on the particular product that can incorporate the veneer(s), the veneers can have any suitable shape, e.g., rectangular, circular, or any other geometrical shape. Typically the veneers can be rectangular, and can have a width ranging from a low of about 1 cm, about 5 cm, about 10 cm, about 15 cm, about 20 cm, or about 25 cm to a high of about 0.6 m, about 0.9 m, about 1.2 m, about 1.8 m, or about 2.4 m. The veneers can have a length ranging from a low of about 0.3 m, about 0.6 m, about 0.9 m, about 1.2 m, or about 1.8 m to a high of about 2.4 m, or about 3 m, about 3.6 m, about 4.3 m, about 4.9 m, about 5.5 m, about 6.1 m, about 6.7 m, about 7.3 m, or about 7.9 m. For example, in a typical veneer product such as plywood, the veneers can have a width of about 1.2 m and a length of about 2.4 m. The veneers can have a thickness ranging from a low of about 0.8 mm, about 0.9 mm, about 1 mm, about 1.1 mm or about 1.2 mm to a high of about 3 mm, about 4 mm, about 5 mm, about 6 mm, about 7 mm, about 8 mm, about 9 mm, or about 10 mm.

Illustrative lignocellulose based composite products or articles produced using the binder compositions discussed and described herein can include, but are not limited to, particleboard, fiberboard such as medium density fiberboard (“MDF”) and/or high density fiberboard (“HDF”), plywood such as hardwood plywood and/or softwood plywood, oriented strand board (“OSB”), laminated veneer lumber (“LVL”), laminated veneer boards (“LVB”), and the like.

Wood based or wood containing products such as particleboard, fiberboard, plywood, and oriented strand board, can have a thickness ranging from a low of about 1.5 mm, about 5 mm, or about 10 mm to a high of about 30 mm, about 50 mm, or about 100 mm. Wood based or wood containing products can be formed into sheets or boards. The sheets or boards can have a length of about 1.2 m, about 1.8 m, about 2.4 m, about 3 m, or about 3.6 m. The sheets or boards can have a width of about 0.6 m, about 1.2 m, about 1.8 m, about 2.4 m, or about 3 m.

Another lignocellulose based composite product can include panels or other multi-layered products. For example, a lignocellulose based composite product can include two, three, four, five, six, seven, eight, nine, ten, or more individual lignocellulose layers bonded together. The binder composition can be contacted with the lignocellulose substrates of any one or more of the individual layers. In one example, the individual lignocellulose layers of a multi-layer product can be veneer. In another example, the individual lignocellulose layers of a multi-layer product can include a plurality of lignocellulose substrates bonded to one another to produce an individual layer. In another example, a multi-layer lignocellulose product can include one or more individual layers that include veneer and one or more layers that include a plurality of lignocellulose substrates bonded to one another to produce an individual layer.

To facilitate discussion of different multilayer lignocellulose based composite structures or product, the following notation is used herein. Each layer of a multi-layer product is denoted “A” or “B,” where “A” indicates a layer of lignocellulose substrates contacted with the binder composition that includes an aldehyde based resin and a copolymer of one or more unsaturated carboxylic acids, one or more unsaturated carboxylic anhydrides, or a combination thereof, and one or more vinyl aromatic derived units (“binder composition layer”), and “B” indicates a layer of lignocellulose substrates contacted with a conventional binder, adhesive, or resin that does not contain the copolymer (“conventional layer”). Where a multilayer product includes more than one A layer or more than one B layer, one or more prime symbols (′, ″, ′″, etc.) are appended to the A or B symbol to indicate layers of the same type that can be the same or can differ in one or more properties, such as, substrate composition, binder concentration, thickness, etc. Finally, the symbols for adjacent layers are separated by a slash (/).

Using this notation, a three-layer film having an inner or core layer of the lignocellulose substrates and a conventional adhesive (B layer), i.e., an adhesive that does not contain the copolymer, disposed between two outer or surface layers containing the binder composition (A layer), i.e., the binder composition includes the aldehyde based resin and the copolymer, would be denoted A/B/A′. Similarly, a five-layer film of alternating conventional/binder composition layers would be denoted A/B/A′/B′/A″. Unless otherwise indicated, the left-to-right or right-to-left order of layers does not matter, nor does the order of prime symbols. For example, an A/B multi-layered product is equivalent to a B/A multi-layered product, and an A/A′/B/A″ multi-layered product is equivalent to an A/B/A′/A″ multi-layered product, for purposes described herein.

A multi-layer lignocellulose based composite product that includes one or more of the binder compositions discussed and described herein (the “A” layer) can be described as having any of the following exemplary structures: (a) two-layers, such as A/A, A/A′, and A/B; (b) three-layers, such as A/B/B′, A/B/A′, A/A′/B, B/A/B′ and A/A′/A″; (c) four-layer, such as A/A′/A″/B, A/A′/B/A″, A/A′/B/B′, A/B/A′/B′, A/B/B′/A′, B/A/A′/B′, A/B/B′/B″, B/A/B′/B″, and A/A′/A″/A′″; (d) five-layers, such as A/A′/A″/A′″/B, A/A′/A″/B/A′″, A/A′/B/A″/A″′, A/A′/A″/B/B′, A/A′/B/A″/B′, A/A′/B/B′/A″, A/B/A′/B′/A″, A/B/A′/A″/B, B/A/A′/A″/B′, A/A′/B/B′/B″, A/B/A′/B′/B″, A/B/B′/B″/A′, B/A/A′/B′/B″, B/A/B′/A′/B″, B/A/B′/B″/A′, A/B/B′/B″/B′″, B/A/B′/B″/B″′, B/B′/A/B″/B″′, and A/A′/A″/A″′/A″″; and similar structures for multi-layer products having six, seven, eight, nine, ten, or any other number of layers.

For example, in a three layered lignocellulose based composite product, the binder composition can be contacted with the lignocellulose substrates of the outer or surface layers and another adhesive, resin, or binder, i.e., not containing the copolymer, can be contacted with the lignocellulose substrates of the inner or “core” layer. In a more particular example, a three layered lignocellulose based composite product can include a binder composition containing the aldehyde based resin and the copolymer in the outer layers and only an aldehyde based resin, i.e., no copolymer, in the inner or core layer. In another example, a three layered lignocellulose based composite product can include a binder composition containing the aldehyde based resin and the copolymer in all three layers, i.e., the outer layers and the core layer. In another example, a three layered lignocellulose based composite product can include a binder composition containing the aldehyde based resin and the copolymer in one outer layer and the other outer layer and the core layer can include only an aldehyde based resin, i.e., no copolymer. In another example, a three layered lignocellulose based composite product can include a binder composition containing the aldehyde based resin and the copolymer in one outer layer and the core layer and the other outer layer can include only an aldehyde based resin, i.e., no copolymer.

In at least one example, a multi-layer lignocellulose based composite product can include a core layer, a first outer layer bonded to a first side of the core layer, and a second outer layer bonded to a second side of the core layer, where the first and the second sides of the core layer oppose one another. At least one of the first and the second outer layers can include a plurality of lignocellulose substrates bonded to one another with an at least partially cured binder composition. The binder composition, prior to curing, can include the aldehyde based resin and the copolymer. The copolymer can optionally be modified by reaction with the one or more base compounds. In another example, both the first and second outer layers can include a plurality lignocellulose substrates bonded to one another with an at least partially cured binder composition. The binder composition, prior to curing, can include the aldehyde based resin and the copolymer. The core layer can also include a plurality of lignocellulose substrates bonded to one another with the same binder composition used to bond the lignocellulose substrates in the first and/or second outer layers or the plurality of substrates in the core layer can be bonded to one another with a different binder composition, e.g., a phenol-formaldehyde resin that does not include the copolymer.

### EXAMPLES

In order to provide a better understanding of the foregoing discussion, the following non-limiting examples are offered. Although the examples may be directed to specific embodiments, they are not to be viewed as limiting the invention in any specific respect. All parts, proportions, and percentages are by weight unless otherwise indicated.

### Example I

A stability study for several different binder compositions, namely comparative examples (CEx. 1-3) and inventive examples (Ex. 1-6), was conducted. Each binder composition was placed in a water bath at 25° C. for a time period of 270 hours. The viscosity of each binder composition was measured periodically using a Brookfield viscometer with a small sample adapter. The viscosity was used as an indicator for the advancement of the binder compositions over the time monitored time period. The results of the stability test are shown in Table 1 below.

Comparative example CEx. 1 was a phenol-formaldehyde (PF) resin that had the following properties: 48.0 wt % solids, pH of 11, a viscosity of about 248 cP, an alkalinity of about 6.1%, and a molar ratio of formaldehyde to phenol (F:P) of about 2.45:1. Comparative examples CEx. 2 and 3 were a styrene maleic anhydride (SMA) resin. The SMA resin had the following properties: 44.5 wt % solids, pH of 8.1, a viscosity of about 605 cP, a molar ratio of styrene to maleic anhydride (S:MA) of about 1:1, a weight average molecular weight (Mw) of about 5,000. The inventive binder compositions (Ex. 1-6) and all other inventive binder compositions discussed herein were combined on a solids basis.

For comparative example CEx. 2, the pH of the SMA was as supplied, which was about 8.1 and is referred to in Tables 1 and 2 as “Unadjusted.” For comparative example CEx. 3, the pH of the SMA was increased from about 8.1 to about 12.1 by adding a sufficient amount of a 50 wt % sodium hydroxide (NaOH) solution to the SMA and is referred to in Tables 1 and 2 as “Adjusted.” Examples 1-3 were prepared by mixing appropriate amounts of the PF resin and the Unadjusted SMA to produce binder compositions containing about 1 wt %, about 2 wt %, and about 3 wt % SMA, based on solids, respectively. Examples 4-6 were prepared by mixing appropriate amounts of the PF resin and the Adjusted SMA to produce binder compositions containing about 1 wt %, about 2 wt %, and about 3 wt % SMA, based on solids, respectively. The pH of the SMA resin was increased to approximately the pH of the PF resin prior to mixing the SMA with the PF resin in order to determine if the pH of the SMA had an effect on the binder composition.

An automated bonding evaluation system (ABES) study was also conducted in order to evaluate the mechanical response (bond strength in this case) of various binder compositions. The ABES test is a lap shear destructive test. The ABES test was conducted according to the test procedure discussed and described in C. Heinemann et al., “Kinetic Response of Thermosetting Adhesive Systems to Heat: Physico-Chemical Versus Mechanical Responses,” in Proc. 6th Pacific Rim Bio-Based Composites Symposium, Portland/USA, Oregon State University 2002, Vol. 1, S. 34-44. Four press or cure times (30, 60, 120, or 180 seconds) for each example were tested. The only difference in the ABES test described in “Kinetic Response of Thermosetting Adhesive Systems to Heat: Physico-Chemical Versus Mechanical Responses” and the ABES test conducted in this example was that the press temperature was 130° C. and the pressure was 1.374 MPa. More particularly, the binder compositions were applied to a pair of maple veneer strips (0.02 inches×0.75 inches×4.5 inches) that were mounted on an ABES and pressed at 130° C. and a pressure of 1.374 MPa for a predetermined time and then pulled apart from each other to measure the shear strength.

The results for the 120 second and 180 second cure times are not discussed because the samples pulled out of the clamps of the ABES instead of pulling apart the bond. The ABES results for the 30 second and 60 second cure times are shown in Table 2 below.

TABLE 1
Viscosity Study

| | | | Viscosity, cP | | | | | |
|---|---|---|---|---|---|---|---|---|
| | | | Time, | Time, | Time, | Time, | Time, | Time, |
| Example | Resin | pH | 0 hrs | 24 hrs | 48 hrs | 144 hrs. | 180 hrs | 276 hrs |
| CEx. 1 | PF | 11.0 | 248 | 285 | 295 | 360 | 396 | 509 |
| CEx. 2 | SMA Unadjusted | 8.1 | 604 | 630 | 678 | 650 | 680 | 715 |
| CEx. 3 | SMA Adj | 12.1 | 88 | 88 | 88 | 90 | 88 | 88 |
| Ex. 1 | 1% SMA Adj | 11.0 | 250 | 258 | 284 | 355 | 398 | 516 |
| Ex. 2 | 2% SMA Adj | 11.0 | 235 | 267 | 290 | 343 | 380 | 519 |
| Ex. 3 | 3% SMA Adj | 11.0 | 244 | 252 | 281 | 328 | 380 | 515 |
| Ex. 4 | 1% SMA Unadjusted | 11.3 | 284 | 298 | 315 | 393 | 455 | 600 |
| Ex. 5 | 2% SMA Unadjusted | 11.2 | 295 | 330 | 337 | 427 | 475 | 640 |
| Ex. 6 | 3% SMA Unadjusted | 11.2 | 300 | 311 | 355 | 463 | 500 | 695 |

For the PF resin (CEx. 1) and the inventive binder compositions of Examples 1-6, the viscosity increased over the monitored time period. For the two SMA resins (CEx. 2 and 3), the viscosity remained relatively constant over the monitored time period. None of the Comparative Examples CEx. 1-3 and Examples 1-6 showed any signs of separation or gelling.

TABLE 2
Cure Time v. Max Stress

| | | | Cure | Max | Fail |
|---|---|---|---|---|---|
| | | pH of SMA | Time, | Stress, | Time, |
| Example | Resin | Component | sec. | MPa | sec. |
| CEx. 1a | PF | | 30 | 2.336 | 0.322 |
| CEx. 2a | SMA Unadj | Unadjusted, 8.1 | 30 | 2.482 | 0.374 |
| CEx. 3a | SMA Adj | Adjusted, 12.1 | 30 | 2.400 | 0.292 |
| Ex. 1a | 1% SMA Unadj | Unadjusted | 30 | 3.703 | 0.527 |
| Ex. 2a | 2% SMA Unadj | Unadjusted | 30 | 3.320 | 0.484 |
| Ex. 3a | 3% SMA Unadj | Unadjusted | 30 | 3.082 | 0.417 |
| Ex. 4a | 1% SMA Adj | Adjusted | 30 | 2.507 | 0.312 |
| Ex. 5a | 2% SMA Adj | Adjusted | 30 | 2.205 | 0.286 |
| Ex. 6a | 3% SMA Adj | Adjusted | 30 | 2.927 | 0.441 |
| CEx. 1b | PF | | 60 | 4.929 | 0.802 |
| CEx. 2b | SMA Unadj | Unadjusted | 60 | 2.982 | 0.389 |
| CEx. 3b | SMA Adj | Adjusted | 60 | 2.485 | 0.303 |
| Ex. 1b | 1% SMA Unadj | Unadjusted | 60 | 6.345 | 1.228 |
| Ex. 2b | 2% SMA Unadj | Unadjusted | 60 | 6.916 | 1.443 |
| Ex. 3b | 3% SMA Unadj | Unadjusted | 60 | 6.123 | 1.151 |
| Ex. 4b | 1% SMA Adj | Adjusted | 60 | 5.270 | 0.909 |
| Ex. 5b | 2% SMA Adj | Adjusted | 60 | 6.201 | 1.294 |
| Ex. 6b | 3% SMA Adj | Adjusted | 60 | 5.718 | 1.051 |

From Table 2, the SMA resin by itself (CEx. 2 and 3) was about equal to the PF resin (CEx. 1a, b) at the 30 second press time, but performed much worse than the PF resin at the 60 second press time. The SMA/PF binder compositions Ex. 1a-3a and 1-3b that included the Unadjusted SMA all substantially out performed the corresponding PF resin (CEx. 1a, b) regardless of press time. More particularly, at the 30 second pres time Examples 1a-3a and 1b-3b had a shear stress of about 58.5%, about 42.1%, about 31.9%, about 53.1%, a bout 79.9%, and about 43.5% greater than the corresponding comparative examples CEx. 1a or 1b. The SMA/PF binder compositions of Ex. 4a-6a and 4b-6b that included the Adjusted SMA, with the exception of Ex. 5a, also substantially out performed corresponding PF resin (CEx. 1a and 1b).

### Example II

A second ABES test was also conducted. More particularly, one comparative resin (CEx. 4) and three inventive binder compositions (Ex. 7-9) were prepared and the ABES test was conducted at different press times (15 sec, 30 sec, 45, sec, 60 sec, 120 sec, or 180 sec) and press temperatures (115° C. or 130° C.). The PF used in CEx. 4 and Ex. 7-9 was a phenol-formaldehyde (PF) resin that had the following properties: 47.0 wt % solids, pH of 11.3, a viscosity of about 210 cP, an alkalinity of about 5.9%, and a molar ratio of formaldehyde to phenol (F:P) of about 2.5:1. The SMA resin used to produce the binder compositions of Examples 7-9 corresponded to the Unadjusted SMA resin of in Example 1.

TABLE 3
Cure Time vs. Max Stress

| | | Cure | Cure | Cure | Max | Fail |
|---|---|---|---|---|---|---|
| | | Temp., | Time, | Stress, | Stress, | Time, |
| Example | Resin | ° C. | sec. | MPa | MPa | sec. |
| CEx. 4a | PF | 115 | 15 | 1.374 | 1.105 | 0.234 |
| Ex. 7a | 1% SMA | 115 | 15 | 1.374 | 0.884 | 0.166 |
| Ex. 8a | 2% SMA | 115 | 15 | 1.374 | 0.877 | 0.163 |
| Ex. 9a | 3% SMA | 115 | 15 | 1.374 | 1.028 | 0.185 |
| CEx. 4b | PF | 115 | 30 | 1.374 | 1.658 | 0.286 |
| Ex. 7b | 1% SMA | 115 | 30 | 1.374 | 1.096 | 0.23 |
| Ex. 8b | 2% SMA | 115 | 30 | 1.374 | 1.356 | 0.234 |
| Ex. 9b | 3% SMA | 115 | 30 | 1.374 | 1.629 | 0.219 |
| CEx. 4c | PF | 115 | 45 | 1.374 | 2.235 | 0.269 |
| Ex. 7c | 1% SMA | 115 | 45 | 1.374 | 1.578 | 0.198 |
| Ex. 8c | 2% SMA | 115 | 45 | 1.374 | 1.934 | 0.249 |
| Ex. 9c | 3% SMA | 115 | 45 | 1.374 | 1.800 | 0.228 |
| CEx. 4d | PF | 115 | 60 | 1.374 | 2.911 | 0.4 |
| Ex. 7d | 1% SMA | 115 | 60 | 1.374 | 2.466 | 0.247 |
| Ex. 8d | 2% SMA | 115 | 60 | 1.374 | 2.523 | 0.303 |
| Ex. 9d | 3% SMA | 115 | 60 | 1.374 | 2.553 | 0.305 |
| CEx. 4e | PF | 115 | 120 | 1.374 | 4.532 | 0.707 |
| Ex. 7e | 1% SMA | 115 | 120 | 1.374 | 3.451 | 0.516 |
| Ex. 8e | 2% SMA | 115 | 120 | 1.374 | 3.376 | 0.514 |
| Ex. 9e | 3% SMA | 115 | 120 | 1.374 | 4.518 | 0.707 |
| CEx. 4f | PF | 115 | 180 | 1.374 | 4.052 | 0.658 |
| Ex. 9f | 3% SMA | 115 | 180 | 1.374 | 5.250 | 0.955 |
| CEx. 4g | PF | 130 | 30 | 1.374 | 2.911 | 0.441 |
| Ex. 7g | 1% SMA | 130 | 30 | 1.374 | 2.478 | 0.295 |
| Ex. 8g | 2% SMA | 130 | 30 | 1.374 | 3.196 | 0.405 |
| Ex. 9g | 3% SMA | 130 | 30 | 1.374 | 3.805 | 0.583 |
| CEx. 4h | PF | 130 | 45 | 1.374 | 3.712 | 0.561 |
| Ex. 7h | 1% SMA | 130 | 45 | 1.374 | 5.338 | 0.944 |
| Ex. 8h | 2% SMA | 130 | 45 | 1.374 | 5.125 | 0.838 |
| Ex. 9h | 3% SMA | 130 | 45 | 1.374 | 4.909 | 0.798 |
| CEx. 4i | PF | 130 | 60 | 1.374 | 5.903 | 1.148 |
| Ex. 7i | 1% SMA | 130 | 60 | 1.374 | 5.794 | 1.041 |
| Ex. 8i | 2% SMA | 130 | 60 | 1.374 | 4.969 | 0.800 |
| Ex. 9i | 3% SMA | 130 | 60 | 1.374 | 5.490 | 0.976 |

As shown in Table 3, at 130° C. and a press time of 30 seconds, the SMA/PF binder compositions of Ex. 8g and 9g out performed the comparative example CEx. 4g. For example, Ex. 9g had a max shear strength of 3.805 MPa, which was about 30.7% greater than comparative example CEx. 4g. Also shown in Table 3, at 130° C. and a press time of 45 seconds the SMA/PF binder compositions of Ex. 7h-9h all out performed the standard PF resin of comparative example CEx. 4h. For example, Ex. 7h had a max shear strength of about 5.338 MPa, which was about 43.8% greater than comparative example CEx. 4h. At the lower cure temperature of about 115° C., as compared to the cure temperature of about 130° C., the PF resin (comparative examples CEx. 4a-f) out performed all of the SMA/PF binder compositions (Ex. 7a-9f). This data indicates that the SMA/PF binder compositions may require a higher curing temperature as compared to the PF binder composition.

### Example III

Four sets of panels were made, namely Comparative Examples CEx. 5 and 6 and two inventive examples (Ex. 10 and 11). Each panel was a combination of 60% surface and 40% core layers, based on thickness. Each panel had two outer or surfaces layers that were bonded to opposing sides of the core layer. The lignocellulose substrates used to produce all panels was Southern Yellow Pine having an average flake size of about 3 inches and having a moisture concentration of about 6 wt % to about 7 wt %.

Preparation of the panels used one of four resins or binder compositions to bind the substrates of the surface layers of each panel and the core layers of each panel. The PF resin used to bind the substrates of the outer layers for all examples, when present, had the following properties: 45.0 wt % solids, pH of 9.9, a viscosity of about 200 cP, an alkalinity of about 2.5%, and a molar ratio of formaldehyde to phenol (F:P) of about 2.5:1. The PF resin used to bind the substrates of the core layer for all examples, when present, referred to as PF_{c}, was the same as the PF resin used in CEx. 4 and Ex. 7-9. The PF resin had about 47.0 wt % solids, pH of 11.3, a viscosity of about 210 cP, an alkalinity of about 5.9%, and a molar ratio of formaldehyde to phenol (F:P) of about 2.5:1. The SMA resin used to bind the substrates in the surface layers and the core layers, when present, was the same SMA resin used in Examples 1-9 above.

The particular resin or binder composition used to bind the substrates of the surface layers and the core layers for the panels of CEx. 5 and 6 and Ex. 10 and 11 are shown in Table 4 below. The SMA/PF binder composition used in Ex. 10 and 11 had a concentration of the SMA resin in an amount of about 3 wt %, based on the weight of the PF resin. The total amount of resin or binder composition combined with the substrates of the surface layers was about 3.5 wt %, based on the dry weight of the substrates. Also added to the mixture of substrates and resin or binder composition was slack wax in an amount of about 1 wt %, based on the dry weight of the substrates. Table 4 below shows the Means Comparison data for the Internal Bond (IB) strength study.

The press used to form the panels was a Wabash Metals Hydraulic Press having press platens of 24 inches×24 inches. The press heated the panels to a temperature of about 210° C.+/−5.5° C. when the panels were pressed.

A press time series was made with the control resins (CEx. 5) with the minimum press time giving approximately a 40 psi internal bond strength (IB). From the press time series three panels were made for each condition at the minimum, minimum plus 20 seconds and minimum plus 40 seconds.

The formed panels were about 0.75 inches thick×18 inches×18 inches at 43 pounds per cubic foot (pcf). As such, the outer or surfaces layers were about 0.225 inches thick and the core layer was about 0.3 inches thick. The internal bond (IB) strength of each panel was measured. For each panel 12 tests were conducted. Each IB test used a 2 inch×2 inch sample. The results of the IB tests are shown in Table 4 below.

TABLE 4
Means Comparison

| | Resin | | Press | IB, psi | IB, psi | IB, psi | IB, psi |
|---|---|---|---|---|---|---|---|
| Example | Surface | Core | Time, sec | Mean | Std. Err. | −95% | +95% |
| CEx. 5a | PFₛ | PF_{c} | 270 | 46.3975 | 3.80685 | 38.8672 | 53.9278 |
| CEx. 6a | SMA | PF_{c} | 270 | 7.30648 | 3.80685 | −0.2238 | 14.8368 |
| Ex. 10a | SMA/PFₛ | PF_{c} | 270 | 57.8542 | 3.80685 | 50.3239 | 65.3845 |
| Ex. 11a | PFₛ | SMA/PF_{c} | 270 | 42.6813 | 3.80685 | 35.1509 | 50.2116 |
| CEx. 5b | PFₛ | PF_{c} | 290 | 52.9646 | 3.80685 | 45.4343 | 60.4949 |
| CEx. 6b | SMA | PF_{c} | 290 | 10.1652 | 3.80685 | 2.63489 | 17.6955 |
| Ex. 10b | SMA/PFₛ | PF_{c} | 290 | 63.1438 | 3.80685 | 55.6134 | 70.6741 |
| Ex. 11b | PFₛ | SMA/PF_{c} | 290 | 49.8848 | 3.80685 | 42.3545 | 57.4151 |
| CEx. 5c | PFₛ | PF_{c} | 310 | 61.1708 | 3.80685 | 53.6405 | 68.7012 |
| CEx. 6c | SMA | PF_{c} | 310 | 11.1706 | 3.80685 | 3.64031 | 18.7009 |
| Ex. 10c | SMA/PFₛ | PF_{c} | 310 | 70.6938 | 3.80685 | 63.1634 | 78.2241 |
| Ex. 11c | PFₛ | SMA/PF_{c} | 310 | 65.7417 | 3.80685 | 58.2114 | 73.272 |

As shown in Table 4, the panel of Ex. 10a-c that used the SMA/PF binder composition to bind the substrates in the surface layers and the PF, resin to bind the substrates in the core layer all surprisingly and unexpectedly had a far greater internal bond strength than the corresponding Comparative Examples CEx. 5a-c that used the two PF resins (PFₛ and PF_{c}) to bind the substrates of the surface and core layers, respectively, regardless of press time. The panel of CEx. 6 that used only the SMA resin to bind the substrates of the surface layers produced a panel that had very low internal bond strength, as shown in Table 4. The panel of EX. 11a and 11b had an internal bond strength lower than the corresponding Comparative Examples CEx. 5a and 5b. However, the panel of Ex. 11c had a greater internal bond strength than that of the corresponding CEx. 5c. Without wishing to be bound by theory, it is believed that the inventive binder compositions containing the combination of SMA and PF resins require longer cure times and/or increased temperature. For example, the core layer is isolated from direct heating via the press platens due to the surface layers. As such, less heat penetrates into the core layer. The longer press time used to produce the panel of Ex. 11c and CEx. 5c should allow more heat to transfer from the press platens into the core layer, thereby improving the cure of the binder composition. Accordingly, it is believed that by further modifying the panel production process via press time and/or temperature, panels having further improved IB made as in Ex. 11 can be recognized. Additionally, using the SMA/PF binder composition of EX. 10 and Ex. 11 to bind both the surface layers and the core layers should also produce panels having even further improved internal bond strengths, at least at press times equivalent to those used to produce the panels of Ex. 10c and 11c.

The results of the internal bond strengths for the panels of CEx. 5 and Ex. 10 and 11 were compared in more detail. More particularly, Tables 5-7 below show the comparison of Ex. 10 to CEx. 5, Ex. 11 to CEx. 5, and Ex. 10 to Ex. 11.

TABLE 5
Internal Bond Strength Comparison between Ex. 10a-c to CEx. 5a-c

| | | Surf. | Core | Press | | | | | | | |
|---|---|---|---|---|---|---|---|---|---|---|---|
| Example | Analysis | Resin | Resin | Time | Mean | SD | 2.50% | 5.00% | Median | 95.00% | 97.50% |
| CEx. 5a | Mean 1 | PFₛ | PF_{c} | 270 | 46.46 | 3.85 | 38.81 | 40.09 | 46.43 | 52.68 | 54.06 |
| | A | | | | | | | | | | |
| Ex. 10a | Mean 1 | SMA/PFₛ | PF_{c} | 270 | 57.85 | 3.86 | 50.19 | 51.60 | 57.87 | 64.08 | 65.41 |
| | B | | | | | | | | | | |
| | Mean | | | 270 | 11.39 | 5.45 | 0.90 | 2.46 | 11.37 | 20.40 | 22.13 |
| | Diff. 1 | | | | | | | | | | |
| | Post. | | | 270 | 62.04 | 5635.00 | −74.80 | −36.76 | −0.47 | 32.44 | 64.78 |
| | Mean 1 | | | | | | | | | | |
| CEx. 5b | Mean 2 | PFₛ | PF_{c} | 290 | 53.04 | 3.38 | 46.33 | 47.49 | 53.04 | 58.57 | 59.86 |
| | A | | | | | | | | | | |
| Ex. 10b | Mean 2 | SMA/PFₛ | PF_{c} | 290 | 63.23 | 5.22 | 53.13 | 55.00 | 63.16 | 71.80 | 73.73 |
| | B | | | | | | | | | | |
| | Mean | | | 290 | 10.19 | 6.19 | −1.99 | 0.19 | 10.07 | 20.36 | 22.45 |
| | Diff. 2 | | | | | | | | | | |
| | Post. | | | 290 | 0.23 | 113.60 | −12.41 | −4.01 | 1.83 | 10.71 | 18.50 |
| | Mean 2 | | | | | | | | | | |
| CEx. 5c | Mean 3 | PFₛ | PF_{c} | 310 | 61.10 | 5.11 | 50.77 | 52.67 | 61.17 | 69.36 | 71.05 |
| | A | | | | | | | | | | |
| Ex. 10c | Mean 3 | SMA/PFₛ | PF_{c} | 310 | 70.72 | 4.49 | 61.77 | 63.45 | 70.69 | 78.09 | 79.66 |
| | B | | | | | | | | | | |
| | Mean | | | 310 | 9.62 | 6.74 | −3.66 | −1.32 | 9.67 | 20.64 | 23.00 |
| | Diff. 3 | | | | | | | | | | |
| | Post. | | | 310 | 0.39 | 332.70 | −36.83 | −18.66 | −1.37 | 17.11 | 34.07 |
| | Mean | | | | | | | | | | |
| | Diff. 3 | | | | | | | | | | |
| | Total | All | All | All | 28.78 | 9.91 | 9.39 | 12.64 | 28.65 | 45.14 | 48.65 |
| | Curve | | | | | | | | | | |
| | Analysis | | | | | | | | | | |

As shown in Table 5, the examples compared are Ex. 10a-c (SMA/PF binder composition in the surface and PF resin in the core) to that of the comparative CEx. 5 (PF resin in the surface and core). At 270 seconds, Ex. 10a exhibited a statistically greater internal bond strength than that of CEx. 5. At 290 seconds and 310 seconds there was no statistical difference at 97.5% confidence level (“C.L.”) A total curve analysis box plot indicates that the panels of Ex. 10a-c out performed the control at all 3 press times.

TABLE 6
Internal Bond Strength Comparison between Ex. 11a-c to CEx. 5a-c

| | | Surf. | Core | Press | | | | | | | |
|---|---|---|---|---|---|---|---|---|---|---|---|
| Example | Analysis | Resin | Resin | Time | Mean | SD | 2.50% | 5.00% | Median | 95.00% | 97.50% |
| CEx. 5a | Mean 1 | PFₛ | PF_{c} | 270 | 42.73 | 3.62 | 35.54 | 36.74 | 42.71 | 48.58 | 49.88 |
| | A | | | | | | | | | | |
| Ex. 11a | Mean 1 | PFₛ | SMA/PFₛ | 270 | 46.39 | 3.86 | 38.74 | 40.16 | 46.41 | 52.61 | 53.94 |
| | B | | | | | | | | | | |
| | Mean | | | 270 | −3.66 | 5.29 | −14.07 | −12.37 | −3.64 | 4.99 | 6.52 |
| | Diff. 1 | | | | | | | | | | |
| | Post. | | | 270 | −2.13 | 141.80 | −33.07 | −16.65 | 0.31 | 16.04 | 32.08 |
| | Mean 1 | | | | | | | | | | |
| CEx. 5b | Mean 2 | PFₛ | PF_{c} | 290 | 49.99 | 4.92 | 40.20 | 41.90 | 49.98 | 58.04 | 59.91 |
| | A | | | | | | | | | | |
| Ex. 11b | Mean 2 | PFₛ | SMA/PFₛ | 290 | 53.04 | 3.44 | 46.39 | 47.62 | 52.99 | 58.68 | 59.95 |
| | B | | | | | | | | | | |
| | Mean | | | 290 | −3.05 | 5.97 | −14.83 | −12.75 | −2.92 | 6.78 | 8.79 |
| | Diff. 2 | | | | | | | | | | |
| | Post. | | | 290 | 7.33 | 509.20 | −13.07 | −6.81 | −0.54 | 4.68 | 10.29 |
| | Mean 2 | | | | | | | | | | |
| CEx. 5c | Mean 3 | PFₛ | PF_{c} | 310 | 65.69 | 4.09 | 57.41 | 58.93 | 65.75 | 72.31 | 73.66 |
| | A | | | | | | | | | | |
| Ex. 11c | Mean 3 | PFₛ | SMA/PFₛ | 310 | 61.20 | 5.25 | 50.73 | 52.70 | 61.16 | 69.82 | 71.66 |
| | B | | | | | | | | | | |
| | Mean | | | 310 | 4.49 | 6.60 | −8.58 | −6.27 | 4.42 | 15.21 | 17.46 |
| | Diff. 3 | | | | | | | | | | |
| | Post. | | | 310 | −0.68 | 81.97 | −18.15 | −9.94 | −0.65 | 8.57 | 18.65 |
| | Mean | | | | | | | | | | |
| | Diff. 3 | | | | | | | | | | |
| | Total | All | All | All | 28.78 | 9.91 | 9.39 | 12.64 | 28.65 | 45.14 | 48.65 |
| | Curve | | | | | | | | | | |
| | Analysis | | | | | | | | | | |

As shown in Table 6, the examples compared are Ex. 11a-c (PF resin in the surface layers and the SMA/PF binder composition in core) to that of the comparative CEx. 5 (PF resin in the surface and core). There was no statistical difference at any of the 3 press times or in the total curve analysis.

TABLE 7
Internal Bond Strength Comparison between Ex. 10a-c to 11a-c

| | | Surf. | Core | Press | | | | | | | |
|---|---|---|---|---|---|---|---|---|---|---|---|
| Example | Analysis | Resin | Resin | Time | Mean | SD | 2.50% | 5.00% | Median | 95.00% | 97.50% |
| Ex. 10a | Mean 1 | SMA/PFs | PFc | 270 | 57.85 | 3.86 | 50.19 | 51.60 | 57.87 | 64.08 | 65.41 |
| | A | | | | | | | | | | |
| Ex. 11a | Mean 1 | PFs | SMA/PFs | 270 | 42.73 | 3.62 | 35.54 | 36.74 | 42.71 | 48.58 | 49.88 |
| | B | | | | | | | | | | |
| | Mean | | | 270 | 15.12 | 5.29 | 4.93 | 6.48 | 15.10 | 23.84 | 25.55 |
| | Diff. 1 | | | | | | | | | | |
| | Post. | | | 270 | 7.11 | 493.30 | −97.84 | −48.05 | 2.68 | 48.96 | 94.55 |
| | Mean 1 | | | | | | | | | | |
| Ex. 10b | Mean 2 | SMA/PFs | PFc | 290 | 63.23 | 5.22 | 53.13 | 55.00 | 63.16 | 71.80 | 73.73 |
| | A | | | | | | | | | | |
| Ex. 11b | Mean 2 | PFs | SMA/PFs | 290 | 49.99 | 4.92 | 40.20 | 41.90 | 49.98 | 58.04 | 59.91 |
| | B | | | | | | | | | | |
| | Mean | | | 290 | 13.24 | 7.14 | −0.89 | 1.67 | 13.13 | 24.95 | 27.32 |
| | Diff. 2 | | | | | | | | | | |
| | Post. | | | 290 | −3.80 | 247.20 | −48.41 | −22.81 | 0.99 | 25.93 | 54.96 |
| | Mean 2 | | | | | | | | | | |
| Ex. 10c | Mean 3 | SMA/PFs | PFc | 310 | 70.72 | 4.49 | 61.77 | 63.45 | 70.69 | 78.09 | 79.66 |
| | A | | | | | | | | | | |
| Ex. 11c | Mean 3 | PFs | SMA/PFs | 310 | 65.69 | 4.09 | 57.41 | 58.93 | 65.75 | 72.31 | 73.66 |
| | B | | | | | | | | | | |
| | Mean | | | 310 | 5.03 | 6.02 | −6.76 | −4.74 | 5.10 | 14.87 | 17.01 |
| | Diff. 3 | | | | | | | | | | |
| | Post. | | | 310 | 0.09 | 243.10 | −27.48 | −13.96 | 0.44 | 15.58 | 33.36 |
| | Mean | | | | | | | | | | |
| | Diff. 3 | | | | | | | | | | |
| | Total | All | All | All | 30.77 | 9.98 | 11.31 | 14.36 | 30.67 | 47.39 | 50.61 |
| | Curve | | | | | | | | | | |
| | Analysis | | | | | | | | | | |

As shown in Table 7, the examples compared are Ex. 10a-c (SMA/PF binder composition in the surface and PF resin in the core) to that of Ex. 11a-c (PF resin in the surface layers and the SMA/PF binder composition in core). At a press time of 270 seconds Ex. 10a out performed the Ex. 11a. At 290 seconds and 310 seconds there was no statistical difference at the 97.5% C.L. A total curve analysis indicates that the panels of Ex. 10a-c out performed the panels of Ex. 11a-c at all 3 press times.

The main data analysis for the examples was done using Bayesian Statistics with the WinBugs program. The algorithm uses MCMC (Markov Chain Monte Carlo) methods to generate points (10,000 points) that map out the curve that best fits the data set. From these simulated data sets the difference of the mean can be determined along with the variation of the difference set. If zero can be in this difference set (at the 95% confidence level), then the two sets are considered to be statistically equivalent. If zero is not in this difference data set, then the two sets are determined to be statistically different at the tested confidence interval. This analysis can be done on a pair of data sets or can be used to compare two curves if several points on the two curves are compared.

The internal bond strength for each example was measured and was determined according to the test procedure provided for in ASTM D1037-06a.

Embodiments described herein further relate to any one or more of the following paragraphs:

1. A lignocellulose based composite product, comprising: a plurality of lignocellulose substrates and an at least partially cured binder composition, wherein the binder composition, prior to curing, comprises: an aldehyde based resin; and a copolymer comprising one or more unsaturated carboxylic acids, one or more unsaturated carboxylic anhydrides, or a combination thereof, and one or more vinyl aromatic derived units.

2. A multi-layer lignocellulose based composite product, comprising: a core layer, a first outer layer bonded to a first side of the core layer, and a second outer layer bonded to a second side of the core layer, wherein the first and the second sides of the core layer oppose one another, wherein the first and the second outer layers each comprise a plurality of lignocellulose substrates bonded to one another with an at least partially cured binder composition, wherein the binder composition, prior to curing, comprises: an aldehyde based resin; and a copolymer comprising one or more unsaturated carboxylic acids, one or more unsaturated carboxylic anhydrides, or a combination thereof, and one or more vinyl aromatic derived units.

3. The lignocellulose based composite product or multi-layer lignocellulose based composite product according to paragraph 1 or 2, wherein the copolymer comprises from about 7 mol % to about 50 mol % of the one or more unsaturated carboxylic acids, the one or more unsaturated carboxylic anhydrides, or the combination thereof, based on a total weight of the one or more unsaturated carboxylic acids, the one or more unsaturated carboxylic anhydrides, or the combination thereof and the one or more vinyl aromatic derived units.

4. The lignocellulose based composite product or multi-layer lignocellulose based composite product according to any one of paragraphs 1 to 3, wherein the copolymer comprises from about 50 mol % to about 93 mol % of the one or more vinyl aromatic derived units, based on a total weight of the one or more unsaturated carboxylic acids, the one or more unsaturated carboxylic anhydrides, or the combination thereof and the one or more vinyl aromatic derived units.

5. The lignocellulose based composite product or multi-layer lignocellulose based composite product according to any one of paragraphs 1 to 4, wherein the one or more unsaturated carboxylic acids comprise maleic acid, aconitic acid, itaconic acid, acrylic acid, methacrylic acid, crotonic acid, isocrotonic acid, citraconic acid, fumaric acid, or any combination thereof, wherein the one or more unsaturated carboxylic anhydrides comprise maleic anhydride, aconitic anhydride, itaconic anhydride, acrylic anhydride, methacrylic anhydride, crotonic anhydride, isocrotonic anhydride, citraconic anhydride, or any combination thereof, and wherein the one or more vinyl aromatic derived units comprise styrene.

6. The lignocellulose based composite product or multi-layer lignocellulose based composite product according to any one of paragraphs 1 to 5, wherein copolymer has a weight average molecular weight (Mw) of about 500 to about 200,000.

7. The lignocellulose based composite product or multi-layer lignocellulose based composite product according to any one of paragraphs 1 to 6, wherein the copolymer has a weight average molecular weight (Mw) of about 1,000 to about 120,000.

8. The lignocellulose based composite product or multi-layer lignocellulose based composite product according to any one of paragraphs 1 to 7, wherein the aldehyde based resin comprises a urea-aldehyde resin, a melamine-aldehyde resin, a phenol-aldehyde resin, a resorcinol-aldehyde resin, a phenol-resorcinol-aldehyde resin, a melamine-urea-aldehyde resin, a phenol-urea-aldehyde resin, or any combination thereof.

9. The lignocellulose based composite product or multi-layer lignocellulose based composite product according to any one of paragraphs 1 to 8, wherein the aldehyde based resin comprises a urea-formaldehyde resin, a melamine-formaldehyde resin, a phenol-formaldehyde resin, a resorcinol-formaldehyde resin, a phenol-resorcinol-formaldehyde resin, a melamine-urea-formaldehyde resin, a phenol-urea-formaldehyde resin, or any combination thereof.

10. The lignocellulose based composite product or multi-layer lignocellulose based composite product according to any one of paragraphs 1 to 9, wherein the aldehyde based resin comprises a phenol-formaldehyde resin, and wherein the copolymer comprises styrene maleic anhydride.

11. The lignocellulose based composite product or multi-layer lignocellulose based composite product according to any one of paragraphs 1 to 10, wherein the aldehyde based resin comprises a phenol-formaldehyde resin, and wherein the copolymer comprises styrene maleic anhydride modified by reaction with one or more base compounds.

12. The lignocellulose based composite product or multi-layer lignocellulose based composite product according to paragraph 11, wherein the one or more base compounds comprise one or more amines, one or more amides, one or more hydroxides, one or more carbonates, or any combination thereof.

13. The lignocellulose based composite product or multi-layer lignocellulose based composite product according to paragraph 12 to, wherein the one or more base compounds is sodium hydroxide, potassium hydroxide, or a combination thereof.

14. The lignocellulose based composite product or multi-layer lignocellulose based composite product according to paragraph 12, wherein the one or more base compounds is ammonia, monoethanolamine, diethanolamine, triethanolamine, or any combination thereof.

15. The lignocellulose based composite product or multi-layer lignocellulose based composite product according to paragraph 12, wherein the one or more base compounds comprise at least one amine and at least one hydroxide.

16. The lignocellulose based composite product or multi-layer lignocellulose based composite product according to any one of paragraphs 1 to 15, wherein the copolymer comprises styrene maleic anhydride modified by reaction with one or more base compounds, wherein the copolymer has a weight average molecular weight (Mw) of about 500 to about 200,000, and wherein the styrene maleic anhydride is present in an amount ranging from about 60 wt % to about 95 wt %, based on a combined weight of the styrene maleic anhydride and the one or more base compounds.

17. The lignocellulose based composite product or multi-layer lignocellulose based composite product according to any one of paragraphs 1 to 16, wherein an amount of the aldehyde based resin in the binder composition ranges from about 1 wt % to about 99.9 wt %, based on a combined solids weight of the aldehyde based resin and the copolymer.

18. The lignocellulose based composite product or multi-layer lignocellulose based composite product according to any one of paragraphs 1 to 17, wherein an amount of the aldehyde based resin in the binder composition ranges from about 80 wt % to about 99.9 wt %, based on a combined solids weight of the aldehyde based resin and the copolymer.

19. The lignocellulose based composite product or multi-layer lignocellulose based composite product according to any one of paragraphs 1 to 18, wherein the lignocellulose based composite product has an internal bond strength greater that a comparative lignocellulose based composite product produced under the same conditions with the same binder composition except the binder composition is free of the copolymer.

20. The lignocellulose based composite product or multi-layer lignocellulose based composite product according to any one of paragraphs 1 to 19, wherein the binder composition, prior to curing, has a solids concentration ranging from about 10 wt % to about 50 wt %.

21. The lignocellulose based composite product or multi-layer lignocellulose based composite product according to any one of paragraphs 1 to 20, wherein the binder composition, prior to curing, has a pH ranging from about 8 to about 12.

22. The lignocellulose based composite product or multi-layer lignocellulose based composite product according to any one of paragraphs 1 to 21, wherein the aldehyde based resin comprises phenol-formaldehyde, and wherein the phenol-formaldehyde has a molar ratio of formaldehyde to phenol ranging from about 1.8 to about 2.6.

23. The lignocellulose based composite product or multi-layer lignocellulose based composite product according to any one of paragraphs 1 to 22, wherein the aldehyde based resin comprises phenol-formaldehyde, and wherein the phenol-formaldehyde has a viscosity of about 50 cP to about 1,500 cP at a temperature of 25° C.

24. The lignocellulose based composite product or multi-layer lignocellulose based composite product according to any one of paragraphs 1 to 23, wherein the aldehyde based resin, prior to curing, is in a powdered form and wherein the copolymer, prior to curing, is an aqueous copolymer.

25. The lignocellulose based composite product or multi-layer lignocellulose based composite product according to any one of paragraphs 1 to 24, wherein the aldehyde based resin, prior to curing, is in an aqueous resin and wherein the copolymer, prior to curing, is in powdered form.

26. The lignocellulose based composite product or multi-layer lignocellulose based composite product according to any one of paragraphs 1 to 25, wherein the binder composition, prior to curing, has a viscosity of about 50 cP to about 1,500 cP at a temperature of 25° C.

27. The lignocellulose based composite product or multi-layer lignocellulose based composite product according to any one of paragraphs 1 to 26, wherein the lignocellulose substrates comprise wood chips, wood fibers, wood flakes, wood strands, wood wafers, wood shavings, wood particles, wood veneer, or any combination thereof.

28. The lignocellulose based composite product or multi-layer lignocellulose based composite product according to any one of paragraphs 1 to 27, wherein the lignocellulose based composite product is a particleboard, a fiberboard, an oriented strand board, laminated veneer lumber, or plywood.

29. A method for preparing a lignocellulose based composite product, comprising: contacting a plurality of lignocellulose substrates with a binder composition, wherein the binder composition comprises: an aldehyde based resin; and a copolymer comprising one or more unsaturated carboxylic acids, one or more unsaturated carboxylic anhydrides, or a combination thereof, and one or more vinyl aromatic derived units; and at least partially curing the binder composition to produce a lignocellulose based composite product.

30. The method according to paragraph 29, wherein at least partially curing the binder composition comprises pressing the lignocellulose substrates contacted with the binder composition.

31. The method according to paragraph 29 or 30, wherein at least partially curing the binder composition comprises heating the lignocellulose substrates contacted with the binder composition.

32. The method according to any one of paragraphs 29 to 31, wherein at least partially curing the binder composition comprises pressing and heating the lignocellulose substrates contacted with the binder composition.

33. The method according to any one of paragraphs 29 to 32, further comprising forming the plurality of lignocellulose substrates into at least a first layer and a second layer; contacting the first and second layers with one another such that at least a portion of each layer contacts the other; and at least partially curing the binder composition contained in the first and second layers.

34. The method according to any one of paragraphs 29 to 33, further comprising forming the plurality of lignocellulose substrates into at least a first layer and a second layer; contacting the first and second layers with opposing sides of a third layer; and at least partially curing the binder composition contained in the first and second layers.

35. The method according to any one of paragraphs 29 to 34, wherein the copolymer comprises from about 7 mol % to about 50 mol % of the one or more unsaturated carboxylic acids, the one or more unsaturated carboxylic anhydrides, or the combination thereof, based on a total weight of the one or more unsaturated carboxylic acids, the one or more unsaturated carboxylic anhydrides, or the combination thereof and the one or more vinyl aromatic derived units.

36. The method according to any one of paragraphs 29 to 35, wherein the copolymer comprises from about 50 mol % to about 93 mol % of the one or more vinyl aromatic derived units, based on a total weight of the one or more unsaturated carboxylic acids, the one or more unsaturated carboxylic anhydrides, or the combination thereof and the one or more vinyl aromatic derived units.

37. The method according to any one of paragraphs 29 to 36, wherein the one or more unsaturated carboxylic acids comprise maleic acid, aconitic acid, itaconic acid, acrylic acid, methacrylic acid, crotonic acid, isocrotonic acid, citraconic acid, fumaric acid, or any combination thereof, wherein the one or more unsaturated carboxylic anhydrides comprise maleic anhydride, aconitic anhydride, itaconic anhydride, acrylic anhydride, methacrylic anhydride, crotonic anhydride, isocrotonic anhydride, citraconic anhydride, or any combination thereof, and wherein the one or more vinyl aromatic derived units comprise styrene.

38. The method according to any one of paragraphs 29 to 37, wherein copolymer has a weight average molecular weight (Mw) of about 500 to about 200,000.

39. The method according to any one of paragraphs 29 to 38, wherein the copolymer has a weight average molecular weight (Mw) of about 1,000 to about 120,000.

40. The method according to any one of paragraphs 29 to 39, wherein the aldehyde based resin comprises a urea-aldehyde resin, a melamine-aldehyde resin, a phenol-aldehyde resin, a resorcinol-aldehyde resin, a phenol-resorcinol-aldehyde resin, a melamine-urea-aldehyde resin, a phenol-urea-aldehyde resin, or any combination thereof.

41. The method according to any one of paragraphs 29 to 40, wherein the aldehyde based resin comprises a urea-formaldehyde resin, a melamine-formaldehyde resin, a phenol-formaldehyde resin, a resorcinol-formaldehyde resin, a phenol-resorcinol-formaldehyde resin, a melamine-urea-formaldehyde resin, a phenol-urea-formaldehyde resin, or any combination thereof.

42. The method according to any one of paragraphs 29 to 41, wherein the aldehyde based resin comprises a phenol-formaldehyde resin, and wherein the copolymer comprises styrene maleic anhydride.

43. The method according to any one of paragraphs 29 to 42, wherein the aldehyde based resin comprises a phenol-formaldehyde resin, and wherein the copolymer comprises a styrene maleic anhydride modified by reaction with one or more base compounds.

44. The method according to any one of paragraphs 29 to 43, wherein the one or more base compounds comprise one or more amines, one or more amides, one or more hydroxides, one or more carbonates, or any combination thereof.

45. The method according to paragraph 44, wherein the one or more base compounds is present and comprises sodium hydroxide, potassium hydroxide, or a combination thereof.

46. The method according to paragraph 44, wherein the one or more base compounds is present and comprises ammonia, monoethanolamine, diethanolamine, triethanolamine, or any combination thereof.

47. The method according to paragraph 44, wherein the one or more base compounds comprise at least one amine and at least one hydroxide.

48. The method according to any one of paragraphs 29 to 47, wherein the copolymer comprises styrene maleic anhydride modified by reaction with one or more base compounds, wherein the first copolymer has a weight average molecular weight (Mw) of about 500 to about 200,000, and wherein the styrene maleic anhydride is present in an amount ranging from about 60 wt % to about 95 wt %, based on a combined weight of the styrene maleic anhydride and the one or more base compounds.

49. The method according to any one of paragraphs 29 to 48, wherein an amount of the aldehyde based resin in the binder composition ranges from about 1 wt % to about 99.9 wt %, based on a combined solids weight of the aldehyde based resin and the copolymer.

50. The method according to any one of paragraphs 29 to 49, wherein an amount of the aldehyde based resin in the binder composition ranges from about 80 wt % to about 99.9 wt %, based on a combined solids weight of the aldehyde based resin and the copolymer.

51. The method according to any one of paragraphs 29 to 50, wherein the lignocellulose based composite product has an internal bond strength greater that a comparative lignocellulose based composite product produced under the same conditions with the same binder composition except the binder composition is free of the copolymer.

52. The method according to any one of paragraphs 29 to 51, wherein the binder composition, prior to curing, has a solids concentration ranging from about 10 wt % to about 50 wt %.

53. The method according to any one of paragraphs 29 to 52, wherein the binder composition, prior to curing, has a pH ranging from about 8 to about 12.

54. The method according to any one of paragraphs 29 to 53, wherein the aldehyde based resin comprises phenol-formaldehyde, and wherein the phenol-formaldehyde has a molar ratio of formaldehyde to phenol ranging from about 1.8 to about 2.6.

55. The method according to any one of paragraphs 29 to 54, wherein the aldehyde based resin comprises phenol-formaldehyde, and wherein the phenol-formaldehyde has a viscosity of about 50 cP to about 1,500 cP when measured at a temperature of about 25° C.

56. The method according to any one of paragraphs 29 to 55, wherein the aldehyde based resin, prior to curing, is in a powdered form and wherein the copolymer, prior to curing, is an aqueous copolymer.

57. The method according to any one of paragraphs 29 to 56, wherein the aldehyde based resin, prior to curing, is in an aqueous resin and wherein the copolymer, prior to curing, is in powdered form.

58. The method according to any one of paragraphs 29 to 57, wherein the lignocellulose substrates comprise wood chips, wood fibers, wood flakes, wood strands, wood wafers, wood shavings, wood particles, wood veneer, or any combination thereof.

59. The method according to any one of paragraphs 29 to 58, wherein the lignocellulose based composite product is a particleboard, a fiberboard, an oriented strand board, laminated veneer lumber, or plywood.

Certain embodiments and features have been described using a set of numerical upper limits and a set of numerical lower limits. It should be appreciated that ranges from any lower limit to any upper limit are contemplated unless otherwise indicated. Certain lower limits, upper limits and ranges appear in one or more claims below. All numerical values are “about” or “approximately” the indicated value, and take into account experimental error and variations that would be expected by a person having ordinary skill in the art.

Various terms have been defined above. To the extent a term used in a claim is not defined above, it should be given the broadest definition persons in the pertinent art have given that term as reflected in at least one printed publication or issued patent. Furthermore, all patents, test procedures, and other documents cited in this application are fully incorporated by reference to the extent such disclosure is not inconsistent with this application and for all jurisdictions in which such incorporation is permitted.

While the foregoing is directed to embodiments of the present invention, other and further embodiments of the invention may be devised without departing from the basic scope thereof, and the scope thereof is determined by the claims that follow.

1. An aqueous binder composition comprising a mixture of a polyol and a hydrolyzed copolymer of maleic anhydride and a vinyl aromatic compound, wherein the hydrolyzed copolymer is solubilized using an alkaline substance, wherein the polyol comprises a monosaccharide, and wherein the binder composition is formaldehyde free.

2. The aqueous binder composition of claim 1, wherein the alkaline substance comprises ammonia, one or more amines, or a mixture thereof.

3. The aqueous binder composition of claim 1, wherein the vinyl aromatic compound is styrene.

4. The aqueous binder composition of claim 1, wherein the aqueous binder composition has a pH above 7.0.

5. The aqueous binder composition of claim 3, wherein the hydrolyzed copolymer contains from 7 mole % to 50 mole % maleic anhydride and from 50 mole % to 93 mole % styrene.

6. The aqueous binder composition of claim 5, wherein the hydrolyzed copolymer contains an unsaturated carboxylic acid in an amount less than 30 mole %, based on the amount of maleic anhydride.

7. The aqueous binder composition of claim 6, wherein the unsaturated carboxylic acid is selected from the group consisting of: aconitic acid, itaconic acid, acrylic acid, methacrylic acid, crotonic acid, isocrotonic acid, citraconic acid, fumaric acid, lower alkyl esters thereof, and mixtures thereof.

8. The aqueous binder composition of claim 5, wherein the hydrolyzed copolymer further contains a non-styrenic vinyl compound in an amount less than 30 mole %, based on the amount of styrene.

9. The aqueous binder composition of claim 8, wherein the non-styrenic vinyl compound is selected from the group consisting of: vinyl acetate, vinyl propionate, vinyl butyrate, vinyl caproate, vinyl 2-ethylhexanoate, vinyl laurate, vinyl stearate, butadiene, isoprene, ethylene, propylene, cyclohexene, vinyl chloride, vinylidene chloride, methyl acrylate, ethyl acrylate, n-propyl acrylate, isopropyl acrylate, n-butyl acrylate, isobutyl acrylate, tert-butyl acrylate, n-hexyl acrylate, cyclohexyl acrylate, 2-ethylhexyl acrylate, acrylonitrile, methacrylonitrile, and mixtures thereof.

10. The aqueous binder composition of claim 5, wherein the hydrolyzed copolymer contains from 20 mole % to 40 mole % maleic anhydride and from 60 mole % to 80 mole % styrene.

11. The aqueous binder composition of claim 1, wherein the polyol further comprises diethanolamine, triethanolamine, ethyl diethanolamine, methyl diethanolamine, ethylene glycol, diethylene glycol, triethylene glycol, hydroxy terminated polyethyleneoxide, glycerine, pentaerythritol, trimethylol propane, sorbitol, a polysaccharide, polyvinyl alcohol, resorcinol, catechol, pyrogallol, glycollated ureas, 1,4-cyclohexane diol, or mixtures thereof.

12. The aqueous binder composition of claim 1, wherein the monosaccharide comprises glucose, fructose, or a mixture thereof, and wherein the alkaline substance comprises ammonia, monoethanolamine, diethanolamine, triethanolamine, or a mixture thereof.

13. The aqueous binder composition of claim 4, wherein the polyol further comprises diethanolamine, triethanolamine, ethyl diethanolamine, methyl diethanolamine, ethylene glycol, diethylene glycol, triethylene glycol, hydroxy terminated polyethyleneoxide, glycerine, pentaerythritol, trimethylol propane, sorbitol, a polysaccharide, polyvinyl alcohol, resorcinol, catechol, pyrogallol, glycollated ureas, 1,4-cyclohexane diol, or mixtures thereof.

14. The aqueous binder composition of claim 13, wherein the monosaccharide comprises glucose, and wherein the alkaline substance comprises ammonia, monoethanolamine, diethanolamine, triethanolamine, or a mixture thereof.

15. A method for binding together a loosely associated mat of fibers comprising:
contacting the fibers with the aqueous binder composition of claim 1; and
heating the fibers and aqueous binder composition to a temperature sufficient to cure the binder composition.

16. A method for binding together a loosely associated mat of fibers comprising:
contacting the fibers with the aqueous binder composition of claim 2; and
heating the fibers and aqueous binder composition to a temperature sufficient to cure the binder composition.

17. A method for binding together a loosely associated mat of fibers comprising:
contacting the fibers with the aqueous binder composition of claim 3; and
heating the fibers and aqueous binder composition to a temperature sufficient to cure the binder composition.

18. A method for binding together a loosely associated mat of fibers comprising:
contacting the fibers with the aqueous binder composition of claim 4; and
heating the fibers and aqueous binder composition to a temperature sufficient to cure the binder composition.

19. A method for binding together a loosely associated mat of fibers comprising:
contacting the fibers with the aqueous binder composition of claim 11; and
heating the fibers and aqueous binder composition to a temperature sufficient to cure the binder composition.

20. A method for binding together a loosely associated mat of fibers comprising:
contacting the fibers with the aqueous binder composition of claim 12; and
heating the fibers and aqueous binder composition to a temperature sufficient to cure the binder composition.

21. A method for binding together a loosely associated mat of fibers comprising:
contacting the fibers with the aqueous binder composition of claim 13; and
heating the fibers and aqueous binder composition to a temperature sufficient to cure the binder composition.

22. A method for binding together a loosely associated mat of fibers comprising:
contacting the fibers with the aqueous binder composition of claim 14; and
heating the fibers and aqueous binder composition to a temperature sufficient to cure the binder composition.

23. A method for binding together a loosely associated mat of fibers comprising:
contacting the fibers with the aqueous binder composition of claim 5; and
heating the fibers and aqueous binder composition to a temperature sufficient to cure the binder composition.

24. A nonwoven fiber mat product comprising fibers bonded together with a cured binder composition obtained by curing the aqueous binder composition of claim 1.

25. A nonwoven fiber mat product comprising fibers bonded together with a cured binder composition obtained by curing the aqueous binder composition of claim 2.

26. A nonwoven fiber mat product comprising fibers bonded together with a cured binder composition obtained by curing the aqueous binder composition of claim 3.

27. A nonwoven fiber mat product comprising fibers bonded together with cured binder composition obtained by curing the aqueous binder composition of claim 4.

28. A nonwoven fiber mat product comprising fibers bonded together with a cured binder composition obtained by curing the aqueous binder composition of claim 5.

29. A nonwoven fiber mat product comprising fibers bonded together with a cured binder composition obtained by curing the aqueous binder composition of claim 11.

30. A nonwoven fiber mat product comprising fibers bonded together with a cured binder composition obtained by curing the aqueous binder composition of claim 12.

31. A nonwoven fiber mat product comprising fibers bonded together with a cured binder composition obtained by curing the aqueous binder composition of claim 13.

32. A nonwoven fiber mat product comprising fibers bonded together with a cured binder composition obtained by curing the aqueous binder composition of claim 14.

33-37. (canceled)

38. The aqueous cured binder composition of claim 1, wherein the alkaline substance comprises ammonia, a primary alkanolamine, a secondary alkanolamine, a tertiary alkanolamine, or a mixture thereof, wherein the monosaccharide comprises glucose, fructose, or a mixture thereof, and wherein the polyol further comprises a polysaccharide, a secondary alkanolamine, a tertiary alkanolamine, or a mixture thereof.

39. The aqueous binder composition of claim 1, wherein the alkaline substance comprises ammonia, a primary alkanolamine, a secondary alkanolamine, a tertiary alkanolamine, or a mixture thereof, and wherein the monosaccharide comprises glucose.

40. The aqueous binder composition of claim 1, wherein the monosaccharide comprises glucose.

41. The aqueous binder composition of claim 1, wherein the polyol comprises the monosaccharide and at least one of diethanolamine and triethanolamine.

42. The aqueous binder composition of claim 2, wherein the one or more amines comprises monoethanolamine, diethanolamine, triethanolamine, or mixtures thereof.
